(19) United States
(12) Patent Application Publication
(10) Pub. No.: US 2025/0362716 A1
(43) Pub. Date: Nov. 27, 2025

(54) FOLDABLE ELECTRONIC DEVICE FOR CHECKING FOLDED FORM AND METHOD THEREFOR

(71) Applicant: Samsung Electronics Co., Ltd., Suwon-si (KR)

(72) Inventors: Gwangho CHOI, Suwon-si (KR); Wooyoung IM, Suwon-si (KR); Yongjun CHOI, Suwon-si (KR); Minkyung HWANG, Suwon-si (KR)

(21) Appl. No.: 19/292,310

(22) Filed: Aug. 6, 2025

Related U.S. Application Data
(63) Continuation of application No. PCT/KR2024/003585, filed on Mar. 22, 2024.

(30) Foreign Application Priority Data
Mar. 28, 2023 (KR) 10-2023-0040711
May 8, 2023 (KR) 10-2023-0059207

(51) Int. Cl. G06F 1/16; H04M 1/02

(52) U.S. Cl. CPC G06F 1/1677; G06F 1/1616; G06F 1/1652; H04M 1/0243; H04M 1/0268; H04M 2250/12

(57) ABSTRACT

An electronic device is provided. The electronic device includes a flexible display, a first housing and a second housing to which the flexible display is mounted and which are connected in a rotatable structure to be folded or unfolded, a geomagnetic sensor, at least one electromagnetic force generation member, memory, comprising one or more storage media, storing instructions, and one or more processors communicatively coupled to the memory, the geomagnetic sensor and at least one antenna, wherein the instructions, when executed by the one or more processors individually or collectively, cause the electronic device to: check a first sensor value based on the first sensor value measured through the geomagnetic sensor being greater than or equal to a specified value, select operation conditions for the at least one electromagnetic force generation member based on at least one sensor value, drive the at least one electromagnetic force generation member based on the operation conditions, and determine a folded state of the first housing and the second housing based on a second sensor value measured by the geomagnetic sensor according to the driving of the at least one electromagnetic force generation member.

### CROSS-REFERENCE TO RELATED APPLICATION(S)

This application is a continuation application, claiming priority under 35 U.S.C. § 365(c), of an International application No. PCT/KR2024/003585, filed on Mar. 22, 2024, which is based on and claims the benefit of a Korean patent application number 10-2023-0040711, filed on Mar. 28, 2023, in the Korean Intellectual Property Office, and of a Korean patent application number 10-2023-0059207, filed on May 8, 2023, in the Korean Intellectual Property Office, the disclosure of each of which is incorporated by reference herein in its entirety.

### BACKGROUND

### 1. Field

The disclosure relates to a foldable electronic device for checking a folded form, and a method therefor. More particularly, the disclosure relates to a method for checking various folded states in the foldable electronic device.

### 2. Description of Related Art

A portable electronic device, which is represented by a smartphone (hereinafter referred to as “electronic device”), has become capable of being equipped with various functions. The electronic device may include a touch screen-based display to allow a user to easily access various functions, and may provide screens of various applications through the display.

Recently, with the spread of flexible displays, the electronic device has deviated from a bar-type, and a foldable electronic device capable of folding or unfolding a flexible display according to folding of a housing using a foldable housing structure has been developed. In such a foldable electronic device, according to the folding of the housing, a folding state may be changed to a folded state or an unfolded state, and a driving state of the electronic device may be changed according to the folding state of the foldable electronic device.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for checking various folded states in foldable electronic device.

Additional aspects will be set forth in part in the description which follows and, in part, will be apparent from the description, or may be learned by practice of the presented embodiments.

In accordance with an aspect of the disclosure, an electronic device is provided. The electronic device includes a flexible display, a first housing and a second housing to which the flexible display is mounted and which are connected in a rotatable structure to be folded or unfolded, a geomagnetic sensor, at least one electromagnetic force generation member, memory, comprising one or more storage media, storing instructions, and one or more processors communicatively coupled to the memory, the geomagnetic sensor and at least one antenna, wherein the instructions, when executed by the one or more processors individually or collectively, cause the electronic device to check a first sensor value based on the first sensor value measured through the geomagnetic sensor being greater than or equal to a specified value, select operation conditions for the at least one electromagnetic force generation member based on at least one sensor value, drive the at least one electromagnetic force generation member based on the operation conditions, and determine a folded state of the first housing and the second housing based on a second sensor value measured by the geomagnetic sensor according to the driving of the at least one electromagnetic force generation member.

In accordance with another aspect of the disclosure, a method performed by an electronic device including a first housing and a second housing to which a flexible display is mounted and which are connected in a rotatable structure to be folded or unfolded is provided. The method includes checking a first sensor value based on the first sensor value being measured to be greater than or equal to a specified value through a geomagnetic sensor of the electronic device, selecting operation conditions for at least one electromagnetic force generation member of the electronic device based on at least one sensor value, driving the at least one electromagnetic force generation member based on the operation conditions, and determining a folded state of the first housing and the second housing based on a second sensor value measured by the geomagnetic sensor according to the driving of the at least one electromagnetic force generation member.

In accordance with another aspect of the disclosure, one or more non-transitory computer-readable storage media storing one or more computer programs including computer-executable instructions that, when executed by one or more processors of an electronic device individually or collectively, cause the electronic device to perform operations, the operations including a method of controlling the electronic device, the electronic device including a first housing and a second housing to which a flexible display is mounted and which are connected in a rotatable structure to be folded or unfolded is provided. The operations comprise checking a first sensor value based on the first sensor value being measured to be greater than or equal to a specified value through a geomagnetic sensor of the electronic device, selecting operation conditions for at least one electromagnetic force generation member of the electronic device based on at least one sensor value, driving the at least one electromagnetic force generation member based on the operation conditions, and determining a folded state of the first housing and the second housing based on a second sensor value measured by the geomagnetic sensor according to the driving of the at least one electromagnetic force generation member.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 illustrates examples related to a structure and a folded form of a foldable electronic device according to an embodiment of the disclosure;

FIG. 3 illustrates examples related to a structure and a folded form of a foldable electronic device according to an embodiment of the disclosure;

FIG. 4 is a block diagram of an electronic device according to an embodiment of the disclosure;

FIG. 5 is a view for explaining examples of an electromagnetic force generation member of a foldable electronic device according to an embodiment of the disclosure;

FIG. 6 is a view for explaining examples of an electromagnetic force generation member of a foldable electronic device according to an embodiment of the disclosure;

FIG. 7 is a view for explaining an example of a geomagnetic sensor value according to an operation of an electromagnetic force generation member of a foldable electronic device according to an embodiment of the disclosure;

FIGS. 8A, 8B, 8C, and 8D are views for explaining examples of an operation of an electromagnetic force generation member for checking various folded states of a foldable electronic device according to an embodiment of the disclosure;

FIG. 9 is a view for explaining examples of an operation of an electromagnetic force generation member of a foldable electronic device according to an embodiment of the disclosure;

FIG. 10 is a flowchart for explaining an operation of a foldable electronic device according to an embodiment of the disclosure;

FIGS. 11A, 11B, 12, and 13 are views for explaining examples of an operation of an electromagnetic force generation member of a foldable electronic device according to various embodiments of the disclosure; and

FIGS. 14, 15, and 16 are views for explaining examples of geomagnetic sensor values according to an operation of a foldable electronic device according to various embodiments of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

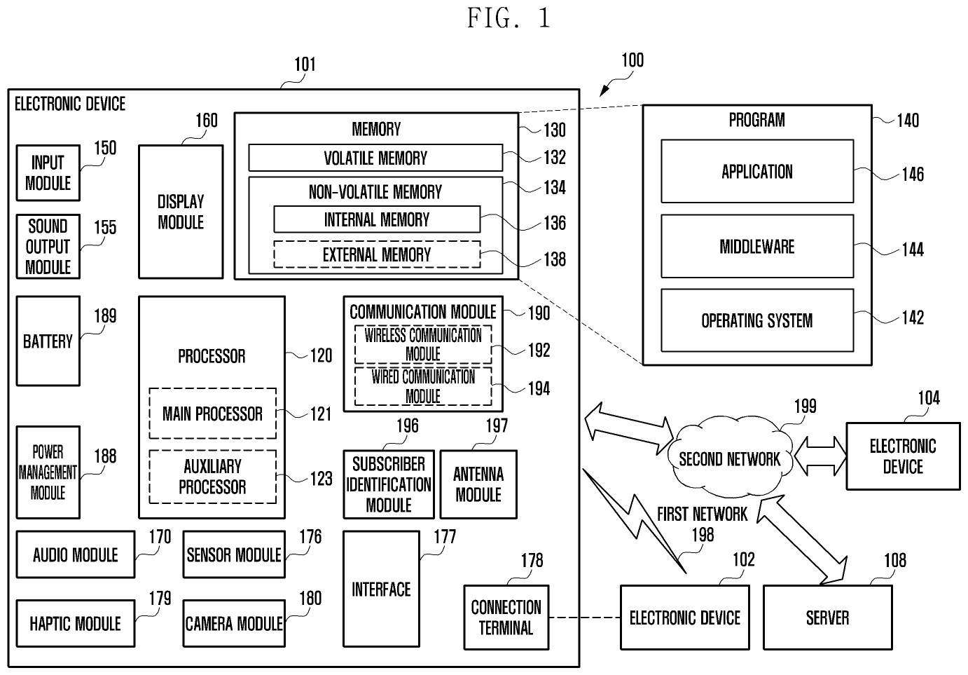

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an example, the electronic device 101 may communicate with the electronic device 104 via the server 108. According to an example, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In some examples, at least one of the components (e.g., the connection terminal 178) may be omitted from the electronic device 101, or one or more other components may be added in the electronic device 101. In some examples, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one example, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an example, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an example, the auxiliary processor 123 (e.g., an image signal processor or a communication processor) may be implemented as part of another component (e.g., the camera module 180 or the communication module 190) functionally related to the auxiliary processor 123. According to an example, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory may include at least one of internal memory 136 and external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an example, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an example, the display module 160 may include a touch sensor adapted to detect a touch, or a pressure sensor adapted to measure the intensity of force incurred by the touch.

The audio module 170 may convert a sound into an electrical signal and vice versa. According to an example, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an example, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an example, the interface 177 may include, for example, a high definition multimedia interface (HDMI), a universal serial bus (USB) interface, a secure digital (SD) card interface, or an audio interface.

The connection terminal 178 may include a connector via which the electronic device 101 may be physically connected with the external electronic device (e.g., the electronic device 102). According to an example, the connection terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an example, the haptic module 179 may include, for example, a motor, a piezoelectric element, or an electric stimulator.

The camera module 180 may capture a still image or moving images. According to an example, the camera module 180 may include one or more lenses, image sensors, image signal processors, or flashes.

The power management module 188 may manage power supplied to the electronic device 101. According to one example, the power management module 188 may be implemented as at least part of, for example, a power management integrated circuit (PMIC).

The battery 189 may supply power to at least one component of the electronic device 101. According to an example, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an example, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an example, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an example, the antenna module 197 may include an antenna including a radiating element composed of a conductive material or a conductive pattern formed in or on a substrate (e.g., a printed circuit board (PCB)). According to an example, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an example, another component (e.g., a radio frequency integrated circuit (RFIC)) other than the radiating element may be additionally formed as part of the antenna module 197.

According to various examples, the antenna module 197 may form an mmWave antenna module. According to an example, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an example, all or some of operations to be executed at the electronic device 101 may be executed at one or more of the external electronic devices (e.g. electronic devices 102 and 104 or the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an example, the external electronic device 104 may include an internet-of-things (IoT) device. The server 108 may be an intelligent server using machine learning and/or a neural network. According to an example, the external electronic device 104 or the server 108 may be included in the second network 199. The electronic device 101 may be applied to intelligent services (e.g., smart home, smart city, smart car, or healthcare) based on 5G communication technology or IoT-related technology.

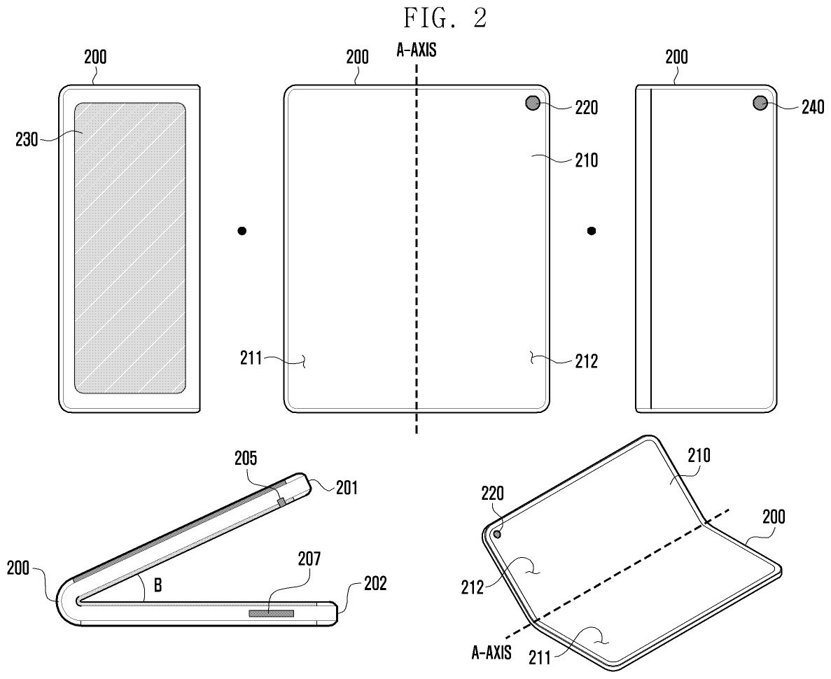

FIG. 2 illustrates an example related to a structure and a form change of an electronic device having a flexible display according to an embodiment of the disclosure.

With reference to FIG. 2, an electronic device 200 (e.g., the electronic device 101 in FIG. 1) according to an embodiment may be a foldable electronic device. According to various embodiments, a display 210 of the electronic device 200 may include at least a part of a structure and/or a function of the display module 160 in FIG. 1.

The foldable electronic device 200 according to an embodiment may include two housings based on a folding axis (e.g., axis A), a flexible display 210 (e.g., the display module 160 in FIG. 1), a front camera 220 (e.g., the camera module 180 in FIG. 1), an auxiliary display 230 (e.g., the display module 160 in FIG. 1), and a rear camera 240 (e.g., the camera module 180 in FIG. 1), and may include at least a part of a structure and/or a function of the electronic device 101 in FIG. 1. The two housings may be overlapped by a hinge structure, and may be folded and overlapped around at least one axis.

Among the two housings constituting a housing of the electronic device 200, a first housing 201 may include a first surface and a second surface, and a second housing 202 may include a third surface and a fourth surface. For example, a folded form, in which the first display 210 of the electronic device 200 is folded based on the axis A, may be a form in which the first surface of the first housing and the third surface of the second housing face and overlap each other. Here, the folded form of the electronic device may be a form in which an angle (e.g., angle B) formed by the first surface of the first housing and the third surface of the second housing is about 0 degrees (e.g., 0 to 5 degrees). For example, the folded form of the electronic device 200 may include a closed form (close state, closed state), or a completely folded form. The display 210 may be divided into a first area 211 and a second area 212 as physically divided areas by folding, the first area may be positioned on the first surface of the first housing, and the second area may be positioned on the third surface of the second housing. The first housing and the second housing may be disposed on both sides about the folding axis (e.g., axis A) and may have a shape that is symmetrical as a whole with respect to the folding axis. With reference to FIG. 2, the first housing may be positioned on the left side based on the folding axis, and the second housing may be positioned on the right side based on the folding axis. The first housing and the second housing may be designed to be foldable toward each other, and in a folded form, the first surface of the first housing and the third surface of the second housing may face and overlap each other. For example, an unfolded form may refer to an open form (open state, an opened state), or a flat (or planar) form (flat state). For example, an unfolded form may include a form in which a first housing and a second housing of the electronic device 300 are disposed at approximately 180 degrees (e.g., 170 to 180 degrees), and the display 210 is exposed.

According to various embodiments, a hinge may be formed between the first housing and the second housing, such that the first housing and the second housing of the electronic device 200 may be folded and overlapped. However, a housing structure in which the electronic device is disposed to the left and right based on a folding axis is only one example, and the electronic device may have a housing that is disposed up and down based on the folding axis.

The first housing and the second housing may vary in an angle (e.g., angle B) or a distance formed with each other depending on whether a form of the electronic device 200 is in an unfolded form (or open form), a folded form (or closed form), or an intermediate form.

According to an embodiment, the electronic device 200 may operate in a folded state, in which the first housing and the second housing are disposed to face each other, or may operate in an unfolded state, in which a first surface of the first housing and a third surface of the second housing substantially face the same direction (e.g., a form in which an angle (e.g., opening/closing angle) implemented between the first housing and the second housing is approximately 180 degrees). For example, when a folded state of the electronic device 200 is released and the angle implemented between the first housing and the second housing falls within a predetermined range (e.g., a range of greater than approximately 5 degrees and less than approximately 170 degrees), the electronic device may operate in an intermediate state.

According to an embodiment, the electronic device 200 may check a folded form according to an angle (e.g., angle B) formed between a first housing and a second housing, based on a sensor value acquired by a sensor 205 (e.g., a sensor module 176 in FIG. 1), for various folded forms such as when the first housing and the second housing are in a folded form, an intermediate form, or an unfolded form as a flat form.

According to an embodiment, the electronic device 200 may operate, for example, an electromagnetic force generation member 207, which will be described below, in order to check an angle formed between a first housing and a second housing, and may acquire a sensor value through a sensor 205 based on a magnetic force generated accordingly.

According to an embodiment, the electronic device 200 may be implemented to mount a sensor 205 on the first housing 201 and to mount an electromagnetic force generation member 207 on the second housing 202 facing the first housing, but is not limited thereto, and the reverse may also be possible.

The electronic device may include an auxiliary display 230 (e.g., the display module 160 in FIG. 1) on at least a part of the first housing or the second housing. With reference to FIG. 2, the auxiliary display 230 may be formed on at least a part of a second surface of the first housing of the electronic device 400. The auxiliary display 230 may be disposed on a fourth surface of the second housing, or may be formed across a part or all of the second surface of the first housing and the fourth surface of the second housing. The auxiliary display 230 may include at least a part of a structure and/or function of the display module 160 in FIG. 1.

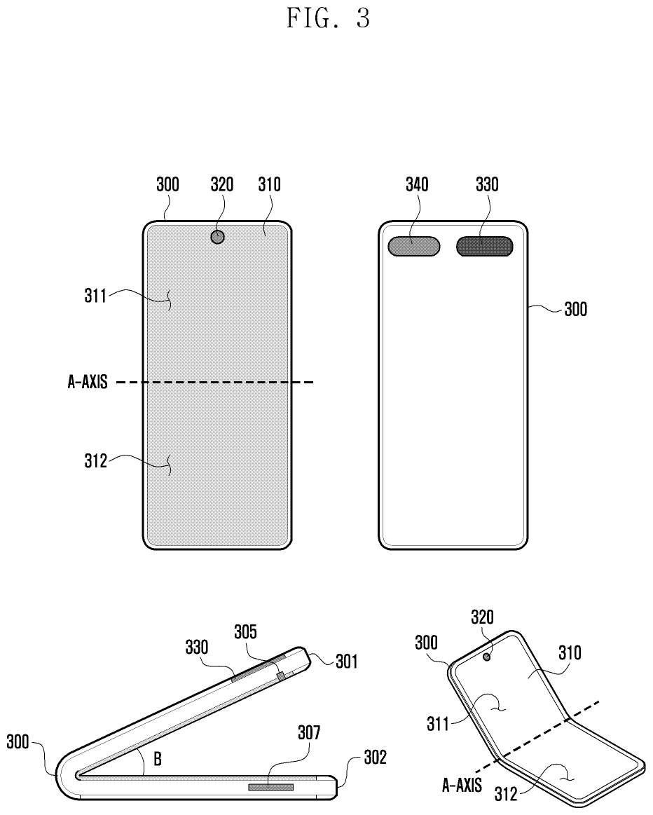

FIG. 3 illustrates examples related to a structure and a form change of an electronic device having a flexible display according to an embodiment of the disclosure.

With reference to FIG. 3, the electronic device 300 (e.g., the electronic device 101 in FIG. 1 or the electronic device 200 in FIG. 2) according to an embodiment may include two housings based on a folding axis (e.g., axis A), a flexible display 310 (e.g., the display module 160 in FIG. 1 or the display 210 in FIG. 2), a front camera 320 (e.g., the camera module 180 in FIG. 1), an auxiliary display 330 (e.g., the display module 160 in FIG. 1), and a rear camera 340 (e.g., the camera module 180 in FIG. 1), and may include at least a part of a structure and/or function of the electronic device 101 in FIG. 1. The two housings may be overlapped by a hinge structure, and may be folded and overlapped around at least one axis.

A first housing 301 and a second housing 302 may be disposed on upper and lower sides about a folding axis (e.g., axis A), and may have a shape that is symmetrical as a whole with respect to the folding axis. The display 310 may be divided into a first area 311 and a second area 312 as physically divided areas by folding, the first area may be positioned on the first surface of the first housing, and the second area may be positioned on the third surface of the second housing. The first housing and the second housing may be disposed on both sides about the folding axis (e.g., axis A) and may have a shape that is symmetrical as a whole with respect to the folding axis. With reference to FIG. 3, the first housing may be positioned on an upper side based on the folding axis, and the second housing may be positioned on a lower side based on the folding axis. The first housing and the second housing may be designed to be foldable toward each other, and in a folded form, the first surface of the first housing and the third surface of the second housing may face and overlap each other.

According to various embodiments, a hinge may be formed between the first housing and the second housing, such that the first housing and the second housing of the electronic device 300 may be folded and overlapped. However, a housing structure in which the electronic device is disposed up and down based on the folding axis is only one example, and the electronic device may have a housing that is disposed left and right based on the folding axis.

The first housing and the second housing may have different angles (e.g., angle B) or distances depending on whether the flexible display 310 of the electronic device 300 is in an unfolded form (or open form), a folded form (or closed form), or an intermediate form. For example, the folded form may include a closed form (close state, closed state) or a completely folded form. For example, the folded form may be a form in which a first surface of the first housing and a third surface of the second housing face and overlap each other. For example, the folded form may be a form in which an angle (e.g., angle B) formed by the first surface of the first housing and the third surface of the second housing is approximately 0 degrees (e.g., 0 to 5 degrees). For example, an unfolded form may refer to an open form (open state, an opened state), or a flat (or planar) form (flat state). For example, an unfolded form may include a form in which a first housing and a second housing of the electronic device 300 are disposed at approximately 180 degrees (e.g., 170 to 180 degrees), and the display 310 is exposed.

According to an embodiment, the electronic device 300 may operate in a folded state, in which the first housing and the second housing are disposed to face each other, or may operate in an unfolded state, in which a first surface of the first housing and a third surface of the second housing substantially face the same direction (e.g., a form in which an angle (e.g., opening/closing angle) implemented between the first housing and the second housing is approximately 180 degrees). For example, the electronic device 300 may operate in an intermediate state in which a folded state is released and an angle implemented between a first housing and a second housing is included within a predetermined range (e.g., a range of greater than approximately 5 degrees and less than approximately 170 degrees).

According to an embodiment, the electronic device 300 may check a folded form according to an angle (e.g., angle B) formed between a first housing and a second housing, based on a sensor value acquired by a sensor 305 (e.g., a sensor module 176 in FIG. 1), for various folded forms such as when the first housing and the second housing are in a folded form, an intermediate form, or an unfolded form as a flat form.

According to an embodiment, the electronic device 300 may operate, for example, an electromagnetic force generation member, which will be described below, in order to check an angle formed between a first housing and a second housing, and may acquire a sensor value through a sensor 305 based on a magnetic field generated accordingly.

According to an embodiment, the electronic device 300 may operate, for example, an electromagnetic force generation member 307 (e.g., the electromagnetic force generation member 307 in FIG. 2), in order to check an angle formed between a first housing and a second housing, and may acquire a sensor value through a sensor 305 based on a magnetic field generated accordingly.

According to an embodiment, the electronic device 300 may be implemented to mount a sensor 305 on the first housing 301 and to mount an electromagnetic force generation member 307 on the second housing 302 facing the first housing, but is not limited thereto, and the reverse may also be possible.

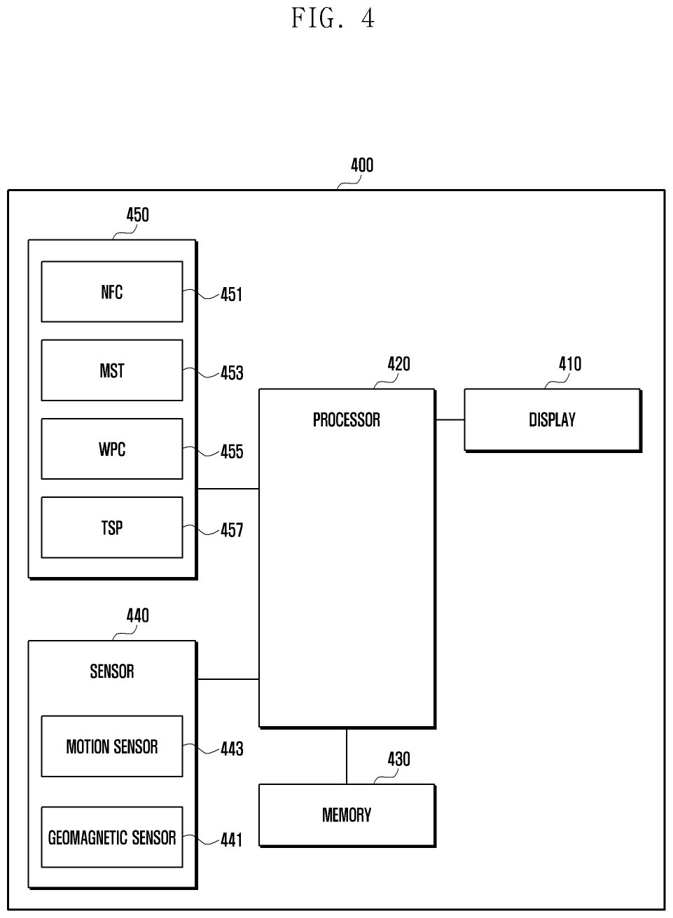

FIG. 4 is a block diagram of an electronic device according to an embodiment of the disclosure.

The electronic device 400 in FIG. 4 (e.g., the electronic device 101 in FIG. 1) may be at least partially similar to the electronic device 200 in FIG. 2 and the electronic device 300 in FIG. 3, or may further include other embodiments of the electronic device. The electronic device 400 may include a foldable electronic device that includes a plurality of housings (e.g., the first housing 201 and the second housing 202 in FIG. 2, or the first housing 301 and the second housing 302 in FIG. 3).

According to an embodiment, the electronic device 400 may operate in a folded state in which a first housing and a second housing are disposed to face each other, or may operate in an unfolded state in which a front surface of the first housing (e.g., the first surface in FIG. 2 or FIG. 3) and a front surface of the second housing (e.g., the third surface in FIG. 2 or FIG. 3) face substantially the same direction (e.g., a form in which an angle (e.g., an opening/closing angle) implemented between the first housing and the second housing is approximately 180 degrees). The electronic device 400 may include an in-folding electronic device. For example, when a folded state of the electronic device 400 is released and the angle implemented between the first housing and the second housing falls within a predetermined range (e.g., a range of greater than approximately 5 degrees and less than approximately 170 degrees), the electronic device may operate in an intermediate state.

According to an embodiment, the electronic device 400 may include an out-folding electronic device, in which a rear surface of the first housing (e.g., the second surface in FIG. 2) and a rear surface of the second housing (e.g., the fourth surface in FIG. 2) are disposed to face each other. For example, when an angle implemented between the first housing and the second housing falls within a predetermined range (e.g., greater than approximately 190 degrees and less than approximately 355 degrees), the out-folding electronic device may operate in an intermediate state.

According to an embodiment, the electronic device 400 may include a display 410 (e.g., the display module 160 in FIG. 1), a processor 420 (e.g., the processor 120 in FIG. 1), memory 430 (e.g., the memory 130 in FIG. 1), a sensor 440 (e.g., the sensor module 176 in FIG. 1) (e.g., the sensor 205 in FIG. 2, or the sensor 305 in FIG. 3), and an electromagnetic force generation member 450 (e.g., the antenna module 197 in FIG. 1 or the display module 160 in FIG. 1) (e.g., the electromagnetic force generation member 207 in FIG. 2, or the electromagnetic force generation member 307 in FIG. 3).

According to an embodiment, the processor 420 of the electronic device 400 may execute a program (e.g., the program 140 in FIG. 1) stored in the memory 430, and may control at least one other component (e.g., a hardware or software component), and may perform various data processing or operations. According to an embodiment, the processor 420 may be operatively, functionally, and/or electrically connected to the memory 430, the display 410, the sensor 440, and the electromagnetic force generation member 450.

According to an embodiment, the memory 430 may store information on a reference value used to check or measure an angle implemented between a first housing and a second housing of the electronic device 400. For example, the information on a reference value may include data on a magnitude, change amount, change direction, and frequency change according to each axis (e.g., x-axis, y-axis, and z-axis) of a sensor value measured by the sensor 440 in various situations. For example, the information on a reference value may include data on a magnitude, change amount, change direction, and frequency change according to each axis (e.g., x-axis, y-axis, and z-axis) of a sensor value measured by the sensor 440 due to various external forces (e.g., external magnetic fields generated by an external magnetic field generating object such as a wireless charger, a magnet, or an accessory). For example, the information on a reference value may include data on a magnitude, change amount, change direction, and frequency change according to each axis of sensor values measured by a geomagnetic sensor, by driving an electromagnetic force generation member based on operation information corresponding thereto under various external force conditions.

According to an embodiment, the memory 430 may store operation-related information for operating the electromagnetic force generation member 450 of the electronic device 400. For example, the operation-related information may include a magnitude of an operation current or power of the electromagnetic force generation member 450, and/or a current direction. For example, the operation-related information may be stored in association with the information on a reference value. For example, the information on a reference value may include data on a magnitude, change amount, change direction, and frequency change of a sensor value measured by the sensor 440 according to each axis (e.g., x-axis, y-axis, and z-axis), and operation-related data of the electromagnetic force generation member 450 (e.g., operation cycle, current intensity, current direction, and a position or type of an operation circuit), as the electromagnetic force generation member 450 is operated. For example, the information on a reference value may include data on a magnitude, change amount, change direction, and frequency change of a sensor value measured by the sensor 440 according to each axis (e.g., x-axis, y-axis, and z-axis), and operation-related data of the electromagnetic force generation member 450 (e.g., operation cycle, current intensity, current direction, and a position or type of an operation circuit), as the electromagnetic force generation member 450 is operated under various conditions in which various external forces are applied.

According to an embodiment, the processor 420 may analyze a sensor value measured by the sensor 440 based on the information on a reference value stored in the memory 430, and may determine an angle implemented between the first housing and the second housing based thereon.

According to an embodiment, the processor 420 may cause a magnetic field to be generated by the electromagnetic force generation member 450, and may analyze a sensor value measured by the sensor 440 based on the information on a reference value stored in the memory 430, and may determine an angle implemented between the first housing and the second housing based thereon.

According to an embodiment, the information on a reference value may include a plurality of angle ranges (e.g., a first angle range, a second angle range) corresponding to an angle implemented between the first housing and the second housing. For example, when an angle implemented between the first housing and the second housing is included within a first angle range, the processor 420 may perform a first function (e.g., a first operation, a first process) set based on the first angle range. For example, when an angle implemented between the first housing and the second housing is included within a second angle range, the processor 420 may perform a second function (e.g., a second operation, a second process) set based on the second angle range. According to an embodiment, the electronic device 400 may recognize an angle implemented between the first housing and the second housing by subdividing the angle into a plurality of angle ranges, and may perform a specific function corresponding to the recognized angle.

According to an embodiment, the electronic device 400 may check an angle implemented between the first housing and the second housing based on a magnetic field measured through the sensor 440.

According to an embodiment, the electronic device 400 may operate, for example, an electromagnetic force generation member 450 in order to check an angle formed between a first housing and a second housing, and may acquire a sensor value through a sensor 440 based on a magnetic field generated accordingly.

According to an embodiment, the electronic device 400 may be implemented such that a sensor 440 is mounted in the first housing, and an electromagnetic force generation member 450 is mounted in a second housing facing the first housing, but is not limited thereto, and the reverse may also be possible.

According to an embodiment, the sensor 440 may include a geomagnetic sensor 441. The geomagnetic sensor 441 may, for example, measure an external magnetic field including the Earth's magnetic field. For example, based on a sensor value of the geomagnetic sensor 441, information on a direction, strength, and/or relative change of the external magnetic field may be acquired.

According to an embodiment, the electronic device 400 may check a folded state of a housing by sensing a magnetic field generated from a magnetic material (e.g., a magnet for opening/closing recognition) through the geomagnetic sensor 441, for example. For example, the folded state may include information related to an angle implemented between the first housing and the second housing.

According to an embodiment, the electronic device 400 may check a folded state by sensing surrounding magnetic fields, including, for example, a magnetic field generated from a magnetic material, through the geomagnetic sensor 441. For example, the folded state may include information related to an angle implemented between the first housing and the second housing.

According to an embodiment, the electronic device 400 may check a folded state by sensing surrounding magnetic fields, including, for example, a magnetic field generated from the electromagnetic force generation member 450, through the geomagnetic sensor 441. For example, the folded state may include information related to an angle implemented between the first housing and the second housing.

According to an embodiment, the electronic device 400 may check a folded form according to an angle formed between the first housing and the second housing. The electronic device 400 may operate in a folded state, in which the first housing and the second housing are disposed to face each other, or may operate in an unfolded state, in which a first surface of the first housing and a third surface of the second housing substantially face the same direction (e.g., a form in which an angle (e.g., opening/closing angle) implemented between the first housing and the second housing is approximately 180 degrees). For example, the electronic device 200 may operate in an intermediate state in which a folded state is released and an angle implemented between a first housing and a second housing is included within a predetermined range (e.g., a range of greater than approximately 5 degrees and less than approximately 170 degrees).

According to an embodiment, the sensor 440 may include a motion sensor 443. For example, the motion sensor 443 may include an accelerometer and/or a gyroscope sensor. For example, information on a posture and/or motion of the electronic device 400 may be acquired based on a sensor value of the motion sensor 443.

According to an embodiment, the electromagnetic force generation member 450 may include various circuits that form a coil for generating a magnetic field by being driven through current, such as an antenna module 197 in FIG. 1 or a touch sensing panel of the display module 160 in FIG. 1, for example. For example, the electromagnetic force generation member 450 may include an antenna including a radiator made of a conductor or conductive pattern formed on a substrate (e.g., a PCB). For example, the electromagnetic force generation member 450 may include a pattern of the touch sensing panel of the display module 160. For example, by driving at least a part of the patterns of the touch sensing panel through current, a magnetic field may be generated by forming closed-loop coils having different positions and/or sizes. For example, the electromagnetic force generation member 450 may include a near field communication (NFC) 451, a magnetic secure transmission (MST) 453, a wireless power consortium (WPC) 455, and/or a touch sensing panel (TSP) 457, which may be used for communication or utilized for wireless charging as a coil using magnetic induction.

According to an embodiment, the display 410 may be disposed in a form that is at least partially coupled to a housing of the electronic device 400 (e.g., the first housing and the second housing), corresponding to a front surface constituting the housing (e.g., the first surface and the third surface in FIG. 2, or the first surface and the third surface in FIG. 3).

According to an embodiment, the display 410 may include a flexible display that is at least partially bendable according to a change in a state (e.g., folded state, unfolded state, intermediate state) of the first housing and the second housing. According to an embodiment, the display 410 may have setting information (e.g., brightness information) adjusted based on an angle implemented between the first housing and the second housing.

According to an embodiment, the processor 420 may check a sensor value of a specific threshold value or more through the geomagnetic sensor 441 according to a change in magnetic field.

According to an embodiment, the processor 420 may supply power to the electromagnetic force generation member 450 according to a set cycle, a magnitude and/or a direction of power. For example, the processor 420 may detect a change in surrounding magnetic field based on a magnetic field generated through the electromagnetic force generation member 450 by using the geomagnetic sensor 441.

According to an embodiment, the processor 420 may vary a magnitude and/or intensity of current through an operation of switching control of the electromagnetic force generation member 450, and may repeatedly output a magnetic field at a specific cycle, and may sense the magnetic field through the geomagnetic sensor 441 and measure respective deviations of magnitudes of a plurality of magnetic fields within the specific cycle, so that even if a change in magnetic field occurs due to magnetic fields such as a magnet fixing case, an accessory including a magnet, or various external magnetic field occurring according to wireless charging, a folded state of the electronic device 400 may be determined.

According to an embodiment, the electronic device 400 in a folded state may be in a state in which a first surface (e.g., the first surface in FIG. 2 or FIG. 3) and a second surface (e.g., the third surface in FIG. 2 or FIG. 3) of the display 410 face each other as the first housing and the second housing are folded. For example, in a folded state, a magnitude of a magnetic field based on the electromagnetic force generation member 450 may maintain a set value. According to an embodiment, in response to a situation in which a folded state is released, a magnetic field may change, and the processor 420 of the electronic device 400 may detect that the folded state is released based on a change in magnitude of the magnetic field acquired through the geomagnetic sensor 441.

According to an embodiment, based on information on a reference value stored in the memory 430 of the electronic device 400, the processor 420 may compare a checked sensor value based on the information on the reference value, in a situation where the electromagnetic force generation member 450 is operated or not operated, and may check an angle implemented between a first housing and a second housing based on a difference value.

According to an embodiment, the processor 420 may adjust, based on a checked angle, screen setting values related to, for example, the flexible display 410.

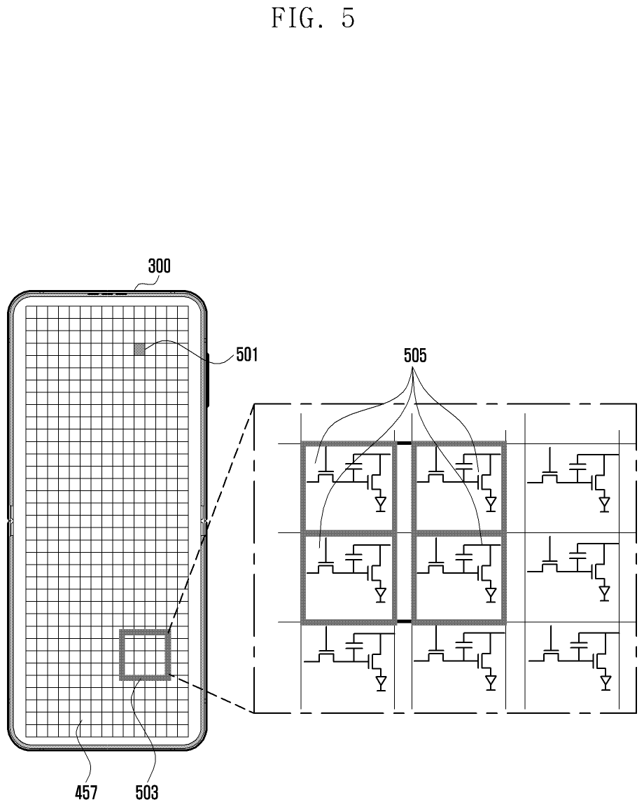

FIG. 5 is a view for explaining examples of an electromagnetic force generation member of a foldable electronic device according to an embodiment of the disclosure.

According to an embodiment, the electromagnetic force generation member (e.g., the electromagnetic force generation member 450 in FIG. 4) may include, for example, the touch sensing panel 457 of the display module 160 in FIG. 1.

According to an embodiment, the touch sensing panel 457 may include a plurality of circuits (e.g., transistor circuits), and each of the transistor circuits may be individually driven.

According to an embodiment, a processor (e.g., the processor 420 in FIG. 4) may drive at least one circuit positioned at a specific position among a plurality of circuits of the touch sensing panel 457 to form a closed loop, so as to perform a coil function and generate a magnetic field. For example, the processor 420 may operate at least one circuit (e.g., four circuits 505) positioned at a position 503 facing a position 501 of a sensor (e.g., the geomagnetic sensor 441 in FIG. 4) when folded, among a plurality of circuits of the touch sensing panel 457, to form various closed-loop coils having different positions and/or sizes, thereby generating a magnetic field of a designated magnitude.

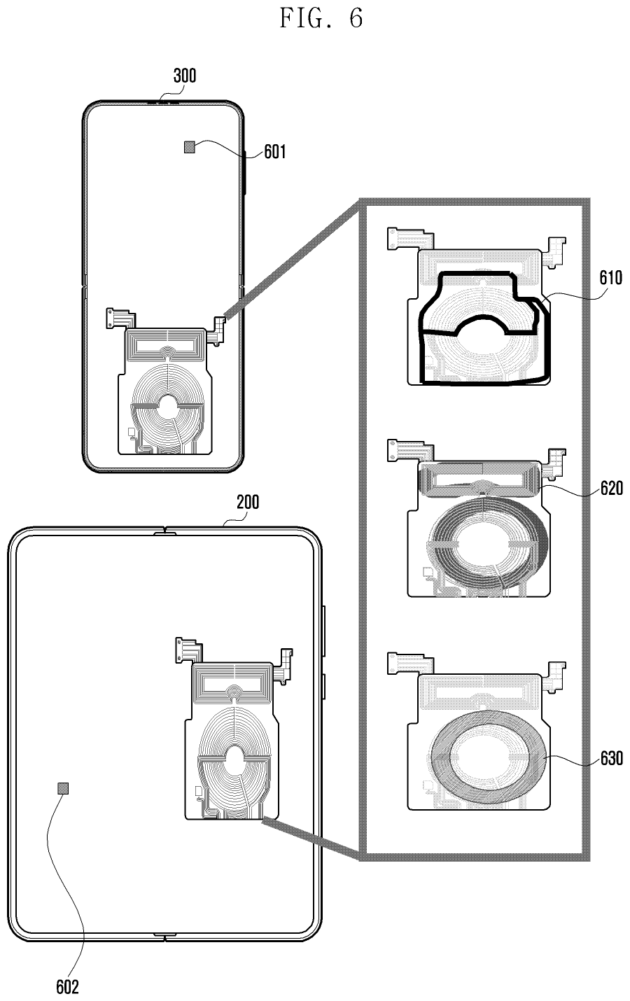

FIG. 6 is a diagram for explaining examples of an electromagnetic force generation member of a foldable electronic device (e.g., the electronic device 200 in FIG. 2 or the electronic device 300 in FIG. 3) according to an embodiment of the disclosure.

According to an embodiment, the electromagnetic force generation member (e.g., the electromagnetic force generation member 450 in FIG. 4) may include various circuit members forming a coil that is driven by current to generate a magnetic field, for example, similar to the antenna module 197 in FIG. 1. For example, the electromagnetic force generation member 450 may include an antenna including a radiator made of a conductor or conductive pattern formed on a substrate (e.g., a PCB). For example, the electromagnetic force generation member 450 may include near field communication (NFC) 610 (e.g., NFC 451 in FIG. 4), magnetic secure transmission (MST) 620 (e.g., MST 453 in FIG. 4), or wireless power consortium (WPC) 630 (e.g., WPC 455 in FIG. 4), which may be used for communication or utilized for wireless charging as coils using magnetic induction.

According to an embodiment, a processor (e.g., the processor 420 in FIG. 4) may check a folded state of the electronic device by measuring a magnetic field generated by driving any one of NFC 610, MST 620, or WPC 630 through a sensor 601 or 602 (e.g., the geomagnetic sensor 441 in FIG. 4).

According to an embodiment, the processor 420 may select any one of the electromagnetic force generation members 450 based on a characteristic of an external magnetic field or a magnetic field, and may drive the selected one in a manner capable of avoiding an influence of the external magnetic field or the magnetic field. For example, the processor 420 may select an electromagnetic force generation member 450 having a frequency or magnetic field characteristic capable of avoiding an external magnetic force or a characteristic of a magnetic field, and may drive the selected electromagnetic force generation member 450 at a designated frequency and/or cycle to generate a magnetic field of a designated magnitude.

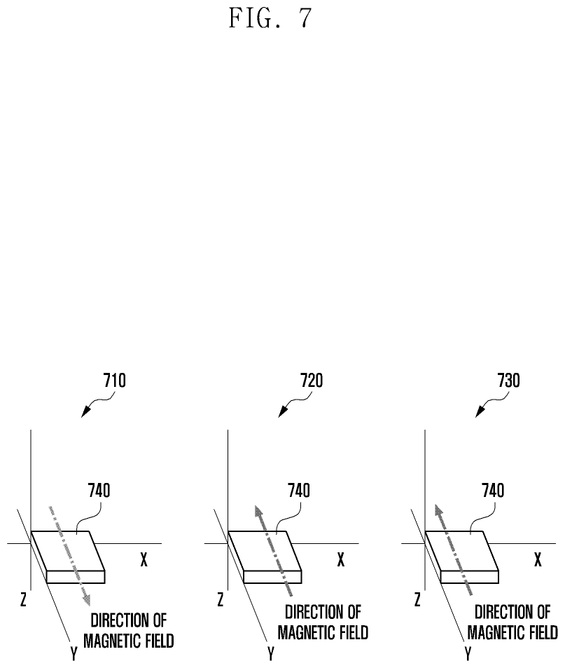

FIG. 7 is a view for explaining an example of a geomagnetic sensor value according to an operation of an electromagnetic force generation member of a foldable electronic device according to an embodiment of the disclosure.

Referring to FIG. 7, in the electronic device (e.g., the electronic device 200, 300, or 400 in FIG. 2, FIG. 3, FIG. 4, FIG. 5, or FIG. 6), for example, according to the position and/or the direction of current of the electromagnetic force generation member including NFC 710 (e.g., NFC 610 in FIG. 6), MST 720 (e.g., MST 620 in FIG. 7), WPC 730 (e.g., WPC 630 in FIG. 7), or TSP (e.g., TSP 457 in FIG. 4 or FIG. 5), an axis among the x-, y-, and z-axes and/or the intensity influenced by the magnetic fields respectively generated therefrom may vary in the geomagnetic sensor 740 (e.g., the geomagnetic sensor 441 in FIG. 4). For example, an axis and/or an intensity of the geomagnetic sensor 740 may be changed under the influence of a current intensity or a folded state (e.g., a folding angle). For example, an axis and/or an intensity of the geomagnetic sensor 740 may be changed under the influence of a current intensity or a folded state (e.g., a folding angle). For example, when NFC 710 is positioned in a −y-axis direction with respect to the geomagnetic sensor 740 and a current flows in a specific direction (e.g., clockwise), there may be no change in the x- and z-axes equal to or greater than the singularity, and a magnetic field may be generated in the +y-axis direction. For example, when MST 720 is positioned in the −y axis direction with respect to the geomagnetic sensor 740, and current flows in a specific direction (e.g., clockwise), there may be no change in the x- and z-axes equal to or greater than the singularity, and a magnetic field may be generated in the −y-axis direction. For example, when WPC 730 is positioned in the −y axis direction with respect to the geomagnetic sensor 740, and current flows in a specific direction (e.g., clockwise), there may be no change in the x- and z-axes equal to or greater than the singularity, and a magnetic field may be generated in the −y-axis direction. For example, in the case of TSP 457, a change in magnetic field in the x-axis, y-axis, or z-axis direction may vary depending on its design position. For example, a sensor value of the geomagnetic sensor 740 may also change due to factors that may change the direction of the magnetic field, such as metal components inside the electronic device.

According to an embodiment, the electronic device may remeasure and update a geomagnetic sensor value, which was measured during a manufacturing process of the electronic device and stored in memory (e.g., the memory 430 in FIG. 4), in a usage environment. The electronic device may check a folding angle based on a sensor value stored in the memory 430.

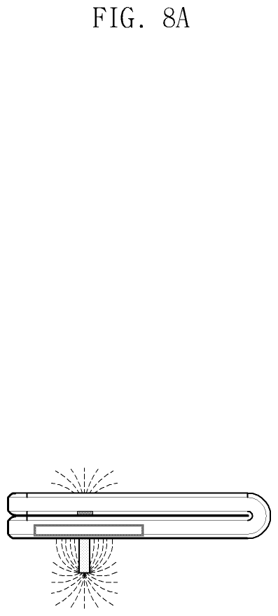

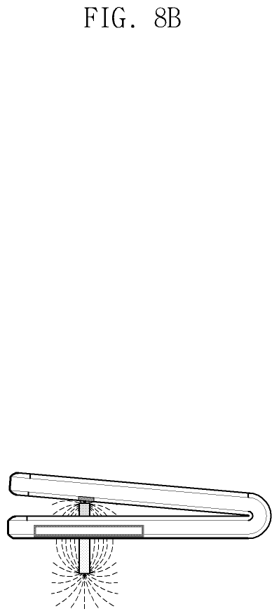

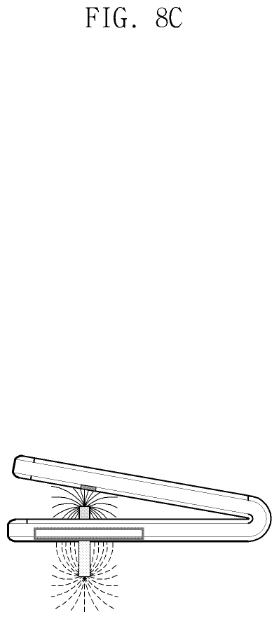

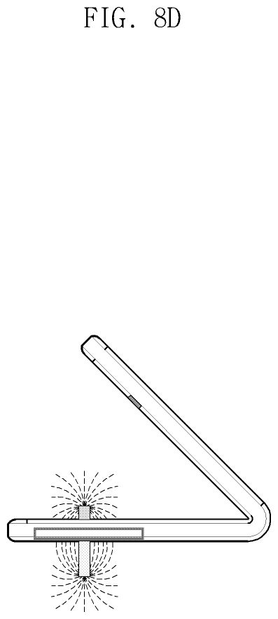

FIGS. 8A, 8B, 8C, and 8D are views for explaining examples of an operation of an electromagnetic force generation member for checking various folded states of a foldable electronic device according to an embodiment of the disclosure.

With reference to FIGS. 8A, 8B, 8C, and 8D, the electronic device (e.g., the electronic device 200, 300, or 400 in FIG. 2, FIG. 3, FIG. 4, FIG. 5, or FIG. 6) may measure a magnitude of a magnetic field detected by a geomagnetic sensor (e.g., the geomagnetic sensor 441 in FIG. 4) in a folded state of the electronic device, for example, at approximately 0 degrees (FIG. 8A), approximately 5 degrees (FIG. 8B), approximately 10 degrees (of FIG. 8C), and approximately 45 degrees (FIG. 8D), as a magnetic field is generated by driving at least one of NFC (e.g., NFC 451 in FIG. 4), MST (e.g., MST 453 in FIG. 4), WPC (e.g., WPC 455 in FIG. 4), and/or a TSP pattern (e.g., TSP 457 in FIG. 4) of the electromagnetic force generation member (e.g., the electromagnetic force generation member 450 in FIG. 4), and may check the folded state of the electronic device based on folded state-related information stored in memory (e.g., the memory 430 in FIG. 4).

Table 1 may illustrate an example of sensor values measured by the geomagnetic sensor 441 and stored in the memory 430. For example, Table 1 may represent values measured by the geomagnetic sensor 441 in a state in which all electromagnetic force generation members are turned off, and values measured by the geomagnetic sensor 441 while each of NFC 610 (e.g., NFC 451 in FIG. 4), MST 620 (e.g., MST 453 in FIG. 4), or WPC 630 (e.g., WPC 455 in FIG. 4) in FIG. 6 is operated, represented as values in units of milliTesla (mT), for example. For example, in Table 1, the values of the geomagnetic sensor 441 may represent values measured under the assumption of a change only in the y-axis, regardless of changes in values of other axes.

TABLE 1

| | | (a) 0 | (b) 5 | (c)10 | (d) 45 |
|---|---|---|---|---|---|
| Type | Axis | degrees | degrees | degrees | degrees |
| electromagnetic | x | 7000 | 4900 | 3430 | 282 |
| force generation | y | −6700 | −4690 | −3283 | −270 |
| member OFF | z | −17500 | −12250 | −8575 | −706 |
| NFC | x | 7000 | 4900 | 3430 | 282 |
| | y | −8000 | −5600 | −3920 | −323 |
| | z | −17500 | −12250 | −8575 | −706 |
| MST | x | 7000 | 4900 | 3430 | 282 |
| | y | −6000 | −4200 | −2940 | −242 |
| | z | −17500 | −12250 | −8575 | −706 |
| WPC | x | 7000 | 4900 | 3430 | 282 |
| | y | −9000 | −6300 | −4410 | −363 |
| | z | −17500 | −12250 | −8575 | −706 |

According to an embodiment, the electronic device may drive the electromagnetic force generation member 450, measure a sensor value through the geomagnetic sensor 440, and determine a folding angle of the electronic device based on a pre-stored sensor value as described in Table 1 above. For example, when the electronic device is in a folded state of approximately 45 degrees, a sensor value measured through the geomagnetic sensor 441 may be approximately 282 milliTesla on the x-axis, approximately −270 milliTesla on the y-axis, and approximately −706 milliTesla on the z-axis when all electromagnetic force generation members are off; and when NFC is operating, the values may be approximately 282 milliTesla on the x-axis, approximately −323 milliTesla on the y-axis, and approximately −706 milliTesla on the z-axis, such that a value change may occur on the y-axis.

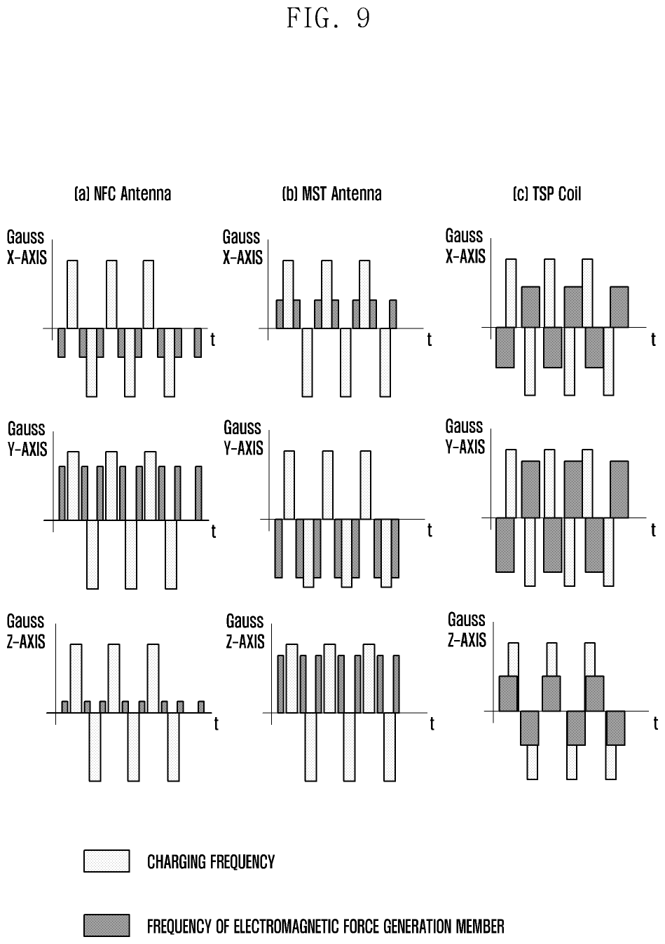

FIG. 9 is a view illustrating examples of operations of the electromagnetic force generation member of the foldable electronic device according to an embodiment of the disclosure.

With reference to FIG. 9, an example in which interference due to an external magnetic field occurs may represent an example in which the electronic device (e.g., the electronic device 200, 300, or 400 in FIG. 2, FIG. 3, FIG. 4, FIG. 5, or FIG. 6) is in a wireless charging state.

According to an embodiment, in an environment in which the electronic device exists, an external magnetic field may be generated, and interference may occur in the operation of the geomagnetic sensor (e.g., the geomagnetic sensor 441 in FIG. 4) that checks the folded state.

According to an embodiment, as the processor of the electronic device (e.g., the processor 420 in FIG. 4) may perform wireless charging using WPC (e.g., WPC 455 in FIG. 4), for example, a magnetic field may be generated by the charging frequency of the WPC 455. In this case, the magnetic field generated by the charging frequency of the WPC 455 may act as an external magnetic field, cause interference in the sensor value of the geomagnetic sensor 441, and may result in a problem in checking the folding angle of the electronic device, thereby causing malfunction.

According to an embodiment, the processor 420 may drive at least one of NFC (e.g., NFC 451 in FIG. 4), MST (e.g., MST 453 in FIG. 4), and/or TSP pattern (e.g., TSP 457 in FIG. 4) to generate a magnetic field. For example, the processor 420 may operate the operating frequency of the NFC 451, MST 453, and/or TSP pattern 457 in a manner that avoids the charging frequency of the WPC 455.

According to an embodiment, based on the folding angle of the electronic device, the information on the folding reference value including the change amount of the geomagnetic sensor 441 according to the current applied to each coil of the electromagnetic force generation member (e.g., the electromagnetic force generation member 450 in FIG. 4) may be checked from the memory (e.g., the memory 430 in FIG. 4), and by comparing with the sensor value measured by the geomagnetic sensor 441, for example, in a situation where a magnetic field is generated due to wireless charging, it may be possible to check whether the electronic device is folded or unfolded.

With respect to FIG. 9, the processor 420 may cause a current to be applied so that an operating frequency, which may avoid the charging frequency of the WPC 455, is generated with respect to each of the x-, y-, and z-axes of the geomagnetic sensor 441, for example, with respect to NFC 451, MST 453, or TSP coil 457.

According to an embodiment, the processor 420, based on a change in magnetic field caused by the WPC 455 being recognized through the geomagnetic sensor 441, may apply a current to any other antenna among the electromagnetic force generation members 450, for example, to the NFC 451, the MST 453, or the TSP coil 457, and may check the folding angle or the folding state of the electronic device.

According to an embodiment, the processor 420, based on recognizing a specific situation such as a case where a magnetic field value change equal to or greater than the magnetic field intensity level for recognizing a magnetic field caused by a wireless charger or a folding angle is detected by the geomagnetic sensor 441, or a case where the change in the x-, y-, and z-axes of the detected magnetic field changes in a direction different from the direction of the magnetic field for recognizing the folding angle of the electronic device, may generate a magnetic field by generating a current through any one of the antennas or coils among the electromagnetic force generation members 450, and may check whether the electronic device is folded. For example, among the x-, y-, and z-axis values of the detected external magnetic field, for example, according to (c) of FIG. 9, the frequency of the z axis may partially overlap with the frequency of the electromagnetic force generation member 450, but the electromagnetic force generation member 450 may be operated using a frequency that avoids an axis having a relatively large frequency variation, for example, the y-axis.

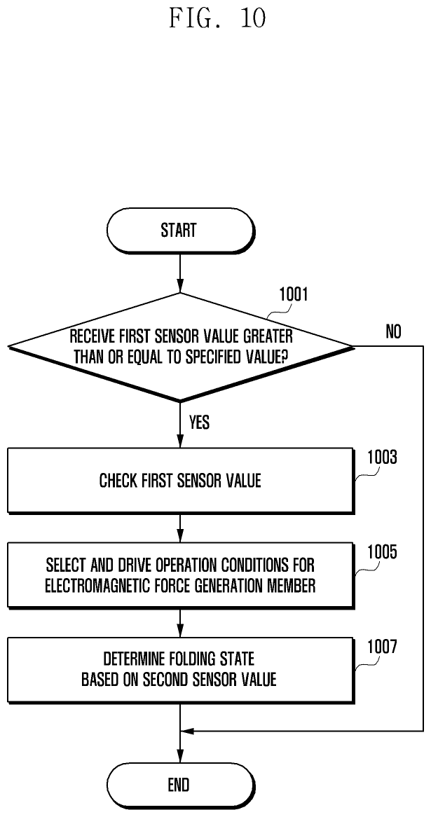

FIG. 10 is a flowchart for explaining an operation of an electronic device according to an embodiment of the disclosure.

In embodiments below, each operation may be performed sequentially, but is not required to be performed sequentially. For example, the order of each operation may be changed, and at least two operations may be performed in parallel.

According to an embodiment, operations 1001 to 1007 may be understood to be performed by a processor (e.g., the processor 420 in FIG. 4) of the electronic device (e.g., the electronic device 200, 300, or 400 in FIG. 2, FIG. 3, FIG. 4, FIG. 5, or FIG. 6).

According to an embodiment, the processor (e.g., the processor 420 in FIG. 4) of the electronic device (e.g., the electronic device 200, 300, or 400 in FIG. 2, FIG. 3, FIG. 4, FIG. 5, or FIG. 6) may check a folded state by measuring a sensor value through a geomagnetic sensor (e.g., the geomagnetic sensor 441 in FIG. 4) based thereon.

According to an embodiment, in operation 1001, the processor may check whether a first sensor value measured through the geomagnetic sensor is greater than or equal to a specified value. The specified value may be a value set based on a sensor value of the geomagnetic sensor that is determined to indicate that a folding state change, including, for example, a change of the folding state from an open state to a closed state or vice versa, has occurred. The specified value may be set to a value exceeding, by a predetermined amount (e.g., approximately 20%), a sensor value of the geomagnetic sensor that is determined to indicate a change in the folding state, for example. The specified value may be adjusted based on an hourly change amount of the sensor value of the geomagnetic sensor, for example.

According to an embodiment, in operation 1003, the processor may check the first sensor value. For example, the processor may compare the first sensor value with a reference value stored in the memory (e.g., the memory 430 in FIG. 4). Information on the reference value may be checked from the memory 430, and the reference value may include data on a change amount, change direction, and frequency change according to each axis (e.g., x-axis, y-axis, and z-axis) of the sensor value measured by the geomagnetic sensor due to various external forces (e.g., external magnetic fields generated by an external magnetic field generating object such as a wireless charger, a magnet, or an accessory). For example, the processor may compare x-, y-, and z-axis values of the first sensor value with the reference value, and may check the type of external force that caused the first sensor value (e.g., whether it is caused by an external magnetic field according to a specific frequency, or by an external magnetic field generated by a wireless charger, or by a specific magnet) and/or may check in which direction the external force is acting.

According to an embodiment, in operation 1005, the processor may select an operation condition of the electromagnetic force generation member (e.g., the electromagnetic force generation member 450 in FIG. 4) based on a comparison between the first sensor value and the reference value, and may drive the electromagnetic force generation member based thereon.

According to an embodiment, the processor may select an operation condition of the electromagnetic force generation member by referring to the operation-related information based on a comparison between the first sensor value and the reference value. For example, the operation-related information may include a magnitude of an operation current or power, a frequency, and/or a direction of the current of the electromagnetic force generation member. For example, the operation-related information may be stored in association with the information on a reference value. For example, a magnitude of an operation current or power, a frequency, and/or a direction of the current of the electromagnetic force generation member may be selected such that an influence therefrom becomes relatively small, by comparing data related to a magnitude, a change amount, a change direction, and a frequency change corresponding to each axis (e.g., an x-axis, a y-axis, and a z-axis) of the first sensor value with data related to a magnitude, a change amount, a change direction, and a frequency change corresponding to each axis (e.g., the x-axis, the y-axis, and the z-axis) of the reference value. For example, a magnitude of an operation current or power and/or a direction of the current of the electromagnetic force generation member may be selected such that an influence therefrom becomes relatively small and a change in the sensor value due to an operation of the electromagnetic force generation member becomes relatively large, by comparing data related to a magnitude, a variation amount, a variation direction, and a frequency variation corresponding to each axis (e.g., an x-axis, a y-axis, and a z-axis) of the first sensor value with data related to a magnitude, a change amount, a change direction, and a frequency change corresponding to each axis (e.g., the x-axis, the y-axis, and the z-axis) of the reference value. For example, the processor may operate the electromagnetic force generation member such that a change in magnetic field becomes relatively large in an axis that is relatively less affected by the corresponding external force, based on a type of the external force and/or a direction in which the external force acts, checked by comparing x-, y-, and z-axis values of the first sensor value with the reference value. For example, when the influence of an external magnetic field is relatively small on the y-axis, the electromagnetic force generation member may be operated such that a change amount of the magnetic field becomes larger on the y-axis by adjusting a frequency, a magnitude, change amount, and change direction in current.

According to an embodiment, when the electromagnetic force generation member includes a plurality of electromagnetic force generation members (e.g., NFC 451, MST 453, WPC 455, and/or TSP 457) as illustrated in FIG. 4, an electromagnetic force generation member, in which a change amount becomes relatively large with respect to an axis on which an influence of an external force is relatively small, may be selected and operated. For example, the processor may select an electromagnetic force generation member in which an influence of an external force is relatively small in a y-axis direction and a change in magnetic field in the y-axis may be relatively large. For example, the processor may drive an electromagnetic force generation member such that a change in magnetic field in a y-axis becomes significantly greater than an external magnetic field, when an influence of the external magnetic field is relatively small in the y-axis direction and the change in magnetic field in the y-axis is relatively large.

According to an embodiment, for example, when charging is in progress by WPC 455, another electromagnetic force generation member (e.g., NFC 451, MST 453, and/or TSP 457) excluding the WPC 455 used for charging may be selected and operated, and based on a magnetic field frequency generated during WPC 455 charging, the selected electromagnetic force generation member may be operated according to an avoidable frequency without performing a separate magnetic field measurement.

According to an embodiment, in operation 1007, the processor may cause a second sensor value to be measured through the geomagnetic sensor according to an operation of the electromagnetic force generation member, and may determine a folded state of the electronic device based on the second sensor value. For example, the processor may determine the folded state of the electronic device by comparing the second sensor value with a reference value stored in memory. The reference value may be determined based on a sensor value measured by the geomagnetic sensor depending on a folded state of the electronic device under various situations, for example, as illustrated in Table 1. For example, the reference value may be set to be smaller than a sensor value measured by the geomagnetic sensor depending on the folded state of the electronic device under various situations.

According to an embodiment, the processor may check whether the electronic device changes from a folded state to an unfolded state, or vice versa, based on reference value-related information.

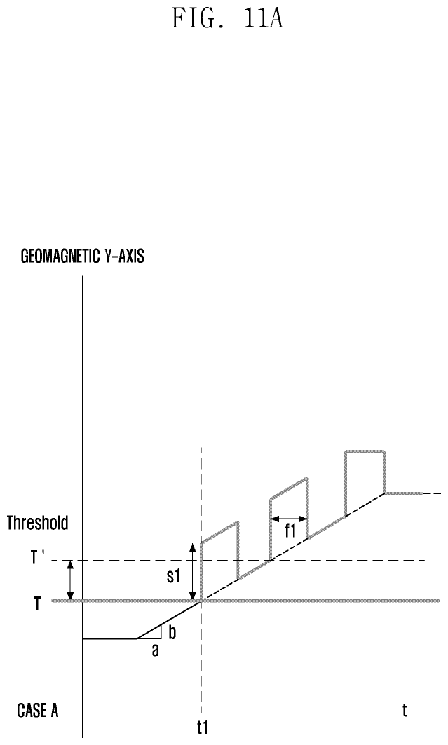

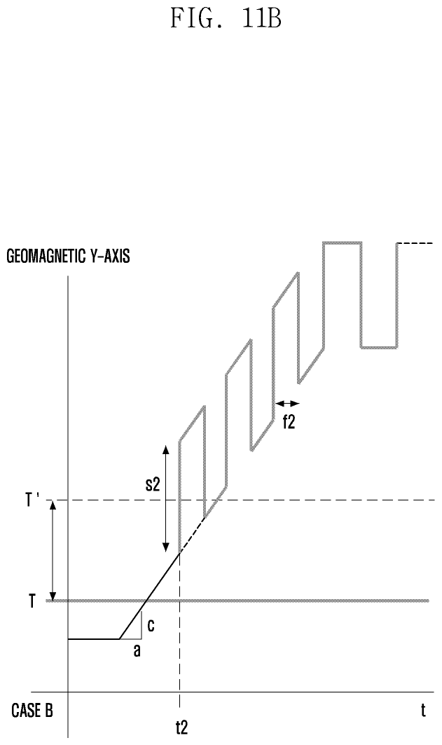

FIGS. 11A, 11B, 12, and 13 are views for explaining examples of an operation of an electromagnetic force generation member of a foldable electronic device according to various embodiments of the disclosure.

With reference to the drawings, the processor (e.g., the processor 420 in FIG. 4) of the electronic device (e.g., the electronic device 200, 300, or 400 in FIG. 2, FIG. 3, FIG. 4, FIG. 5, or FIG. 6) may check a folded state by measuring a sensor value through a geomagnetic sensor (e.g., the geomagnetic sensor 441 in FIG. 4) based thereon. In the drawings, a vertical axis may indicate a magnetic field intensity (e.g., mT), and a horizontal axis may indicate a change in time (e.g., seconds). By measuring sensor values according to a designated cycle (e.g., 1 second or less) through the geomagnetic sensor, graphs as illustrated may be derived respectively. A specified value T may be, for example, a threshold value for determining a folded state.

According to an embodiment, the specified value T may be preset, and may be changed depending on a situation. For example, when a gradient value (acceleration) of a change amount in magnetic field is calculated and the magnetic field is determined to change faster than a general folding operation, the specified value T may be lowered, and current may be applied to a specific electromagnetic force generation member to determine whether folding has occurred. Accordingly, a response speed for determining the folding operation may be increased.

With reference to FIGS. 11A and 11B, the processor may operate the electromagnetic force generation member (e.g., the electromagnetic force generation member 450 in FIG. 4) at a specific point in time t1 or t2 based on the operation current magnitude s1 or s2 and frequency f1 or f2, based on the fact that the sensor value of the geomagnetic sensor exceeds a specified value T while the electronic device is in a folded state.

Referring to FIGS. 11A and 11B, it may be confirmed that the gradient of the change amount of the external force or the change rate (derivative value) of the external magnetic field b/a in the left diagram FIG. 11A is relatively smaller than c/a in the right diagram FIG. 11B.

According to an embodiment, based on the change rate of the external force, a specified value, a point in time of operation, or an operation cycle for determining whether to operate the electromagnetic force generation member may be changed. For example, when the change rate of the external force is relatively large, the specified value may be set higher or the operation cycle may be set faster.

According to an embodiment, when it is checked that the external magnetic field operates at a specific frequency, the electromagnetic force generation member may be operated to avoid the corresponding frequency based on the frequency of the external magnetic field.

According to an embodiment, the processor may re-set a specified value of the geomagnetic sensor for determining whether to operate the electromagnetic force generation member, to a value including an external magnetic field, when a sensor value is maintained for a predetermined time or more based on a change in the external magnetic field according to operation data of the geomagnetic sensor.

According to an embodiment, the processor may increase a current intensity of the electromagnetic force generation member in proportion to a change amount of the external magnetic field. Accordingly, the electromagnetic force generation member may be operated such that a change amount of a magnetic field generated by the electromagnetic force generation member becomes equal to or greater than a required change amount for determining the folded state.

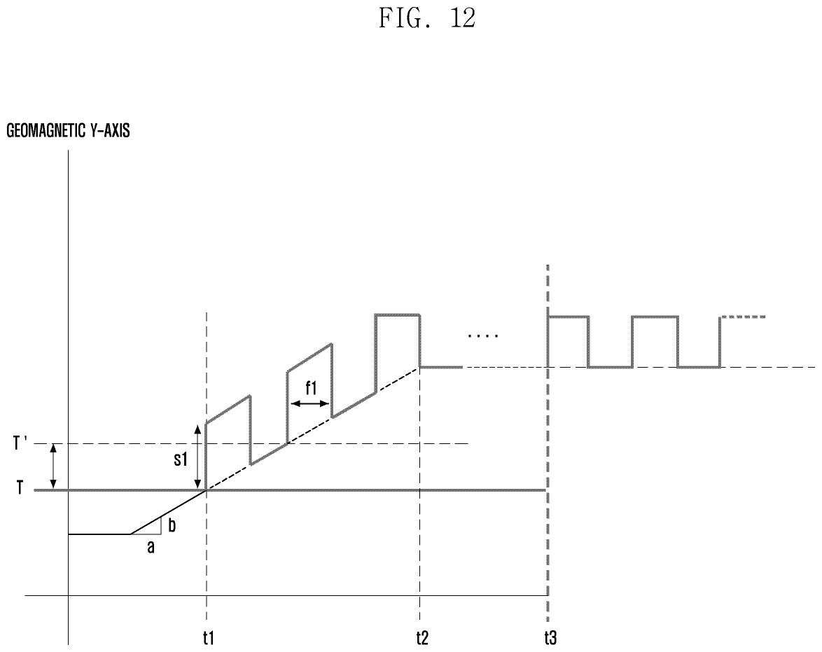

With reference to FIG. 12, the processor may operate the electromagnetic force generation member (e.g., the electromagnetic force generation member 450 in FIG. 4) at a specific point in time t1 based on the operation current magnitude s1 and frequency f1, based on the fact that the sensor value of the geomagnetic sensor exceeds a specified value T while the electronic device is in a folded state.

According to an embodiment, based on the magnetic field of the electromagnetic force generation member being maintained identically for a predetermined time or more (e.g., a t2 to t3 interval) after a specific point in time t2, the processor may update information related to a reference value for checking a folded state of the electromagnetic force generation member, based on the corresponding magnetic field.

According to an embodiment, the processor may not adjust reference value-related information according to the current intensity of the electromagnetic force generation member, based on a change amount of the electromagnetic force generation member, which may be checked as an unfolded state, being less than or equal to the specified value.

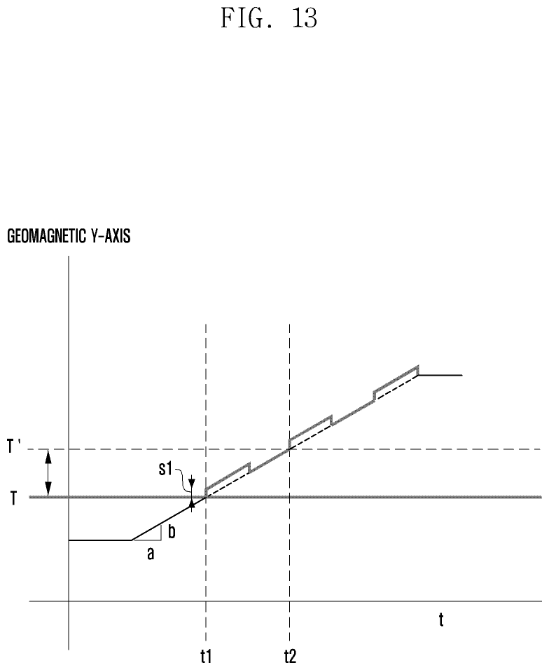

With reference to FIG. 13, although the electromagnetic force generation member was operated as a sensor value exceeded a specified value T due to a change in the sensor value on a specific axis of the geomagnetic sensor, it may be determined that the electronic device is in an unfolded state, for example, based on the determination that a sensor value is not checked for a predetermined period t1 to t2 or a change amount s1 equal to or less than a reference value T′ is measured, and a corresponding operation (e.g., display turn-on) may be performed. The reference value T′ may be determined to be a value within a designated range (e.g., 20%) with respect to the specified value.

According to an embodiment, when a folding or unfolding event of the electronic device occurs, an electromagnetic force generation member may be driven, and geomagnetic change data corresponding to driving conditions for each electromagnetic force generation member in the x-, y-, and z-axis of the geomagnetic sensor may be stored in memory, for example, as reference value-related information, and the stored reference value-related information may be updated.

According to an embodiment, the processor may check which of the x-, y-, or z-axis directions the external force is applied to, and may change the axis used to determine a folded state or unfolded state of the electronic device by driving the electromagnetic force generation member based on the axis not subjected to the external force or subjected to a relatively smaller influence, in order to prevent malfunction from the external force. For example, it may be designed such that the x-, y-, or z-axis of the magnetic field generated by changing the driving conditions of the electromagnetic force generation member is changed.

According to an embodiment, the processor may select and drive an electromagnetic force generation member capable of generating a magnetic field on an axis that may avoid the external force, among the electromagnetic force generation members, in response to an axis or change where the external force is applied, or may drive it by adjusting driving conditions such as a current intensity, direction, or frequency.

According to an embodiment, the processor may check whether a value caused by an external force continuously exists, and may modify a specified value by changing it by a change amount due to the external force based on the continuous existence, and may cause a magnetic field to be generated by selecting and driving an electromagnetic force generation member, such that a folded state of the electronic device may be detected through the geomagnetic sensor.

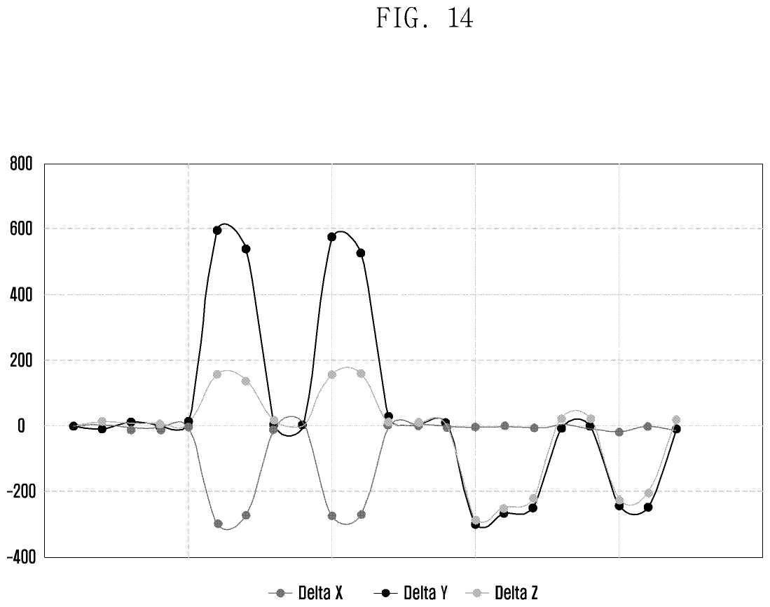

FIGS. 14, 15, and 16 are views for explaining examples of geomagnetic sensor values according to an operation of a foldable electronic device according to various embodiments of the disclosure.

With reference to the drawings, the processor (e.g., the processor 420 in FIG. 4) of the electronic device (e.g., the electronic device 200, 300, or 400 in FIG. 2, FIG. 3, FIG. 4, FIG. 5, or FIG. 6) may check a folded state by measuring a sensor value through a geomagnetic sensor (e.g., the geomagnetic sensor 441 in FIG. 4) based thereon. In the drawings, a vertical axis may indicate a magnetic field intensity (e.g., mT), and a horizontal axis may indicate a change in time (e.g., seconds). Graphs as illustrated may be derived by measuring sensor values (mT) of each of the x-axis, y-axis, and z-axis at a designated cycle (e.g., approximately 1 second) through the geomagnetic sensor.

Table 2 below may represent a change in magnetic field of the x-, y-, and z-axis caused by a current applied to the WPC antenna (e.g., WPC 455 in FIG. 4) when the external magnetic field is extremely weak.

TABLE 2

| | RAW DATA(mT) | | | Delta | | |
|---|---|---|---|---|---|---|
| | x | y | z | x | y | z |
| Current OFF | 49 | 157 | 4 | 0 | 0 | 0 |
| (Reference) | 46 | 147 | 14 | −3 | −10 | 10 |
| | 39 | 167 | 14 | −10 | 10 | 10 |
| | 43 | 157 | 9 | −6 | 0 | 5 |
| | 39 | 167 | 9 | −10 | 10 | 5 |
| Current direction | −250 | 755 | 162 | −299 | 598 | 158 |
| Forward direction | −226 | 698 | 143 | −275 | 541 | 139 |
| Current OFF | 39 | 161 | 23 | −10 | 4 | 19 |
| | 53 | 161 | 9 | 4 | 4 | 5 |
| Current direction | −226 | 731 | 162 | −275 | 574 | 158 |
| Forward direction | −223 | 684 | 164 | −272 | 527 | 160 |
| Current OFF | 49 | 184 | 14 | 0 | 27 | 10 |
| | 49 | 161 | 11 | 0 | 4 | 7 |
| | 46 | 164 | 7 | −3 | 7 | 3 |
| Current direction | 43 | −142 | −280 | −6 | −299 | −284 |
| Reverse direction | 46 | −111 | −247 | −3 | −268 | −251 |
| | 43 | −91 | −220 | −6 | −248 | −224 |
| Current OFF | 49 | 147 | 26 | 0 | −10 | 22 |
| | 39 | 154 | 23 | −10 | −3 | 19 |
| Current direction | 29 | −84 | −220 | −20 | −241 | −224 |
| Reverse direction | 46 | −91 | −204 | −3 | −248 | −208 |
| Current OFF | 33 | 147 | 23 | −16 | −10 | 19 |
| | 49 | 147 | 16 | 0 | −10 | 12 |

With reference to Table 2 as described above, it can be seen that a magnetic field may be formed by applying a current to the WPC antenna, and a change direction of the x-, y-, and z-axis of the magnetic field may be adjusted by adjusting a frequency. For example, when the external magnetic field is extremely weak, with reference to the first row of Table 2, the magnetic field may be measured to be approximately 40 mT, 160 mT, and 10 mT in the x-, y-, and z-axis, respectively, in a state in which WPC antenna is turned off, and with reference to the second row, in a state where the current direction is applied in the forward direction, the magnetic field may be measured to be approximately −230 mT, 700 mT, and 160 mT in the x-, y-, and z-axis, respectively, such that a change amount (delta) of approximately −270 mT, 540 mT, and 150 mT may be measured compared to the antenna turned-off state. FIG. 14 is a graph generated based on the data of Table 2, and it can be seen that, for example, as the current of the WPC antenna is turned on or off, or operated by a specific frequency, the change amount (Delta) of the x-, y-, and z-axis data of the magnetic field changes significantly in the x-axis and y-axis directions, for example, and it can be seen that, as the direction of the current is reversed, data in the magnetic field changes in the opposite direction along the x-, y-, and z-axes. Table 3 below may illustrate an example in which, in a state where an external magnetic field exists, as the electronic device is folded, an electromagnetic force generation member is driven, and a magnetic field change amount of the x-, y-, and z-axis is measured through a geomagnetic sensor.

TABLE 3

| | RAW DATA(mT) | | | Delta | | |
|---|---|---|---|---|---|---|
| | x | y | z | x | y | z |
| Current OFF | 4850 | −4133 | −14485 | 0 | 0 | 0 |
| | 4840 | −4130 | −14490 | −10 | 3 | −5 |
| | 4843 | −4130 | −14478 | −7 | 3 | 7 |
| | 4843 | −4140 | −14485 | −7 | −7 | 0 |
| Current ON | 4710 | −3559 | −14430 | −140 | 574 | 55 |
| | 4710 | −3586 | −14430 | −140 | 547 | 55 |
| | 4727 | −3610 | −14435 | −123 | 523 | 50 |
| | 4717 | −3630 | −14442 | −133 | 503 | 43 |
| Current OFF | 4837 | −4107 | −14457 | −13 | 26 | 28 |
| | 4830 | −4120 | −14447 | −20 | 13 | 38 |
| | 4820 | −4113 | −14435 | −30 | 20 | 50 |
| | 4837 | −4097 | −14426 | −13 | 36 | 59 |
| Current ON | 4697 | −3536 | −14385 | −153 | 597 | 100 |
| | 4707 | −3606 | −14394 | −143 | 527 | 91 |
| | 4710 | −3606 | −14402 | −140 | 527 | 83 |
| | 4694 | −3627 | −14385 | −156 | 506 | 100 |
| Current OFF | 4810 | −4093 | −14399 | −40 | 40 | 86 |
| | 4807 | −4090 | −14380 | −43 | 43 | 105 |
| | 4800 | −4080 | −14359 | −50 | 53 | 126 |
| | 4797 | −4083 | −14359 | −53 | 50 | 126 |
| Current ON | 4667 | −3559 | −14332 | −183 | 574 | 153 |
| | 4674 | −3576 | −14325 | −176 | 557 | 160 |
| | 4674 | −3600 | −14313 | −176 | 533 | 172 |
| | 4674 | −3600 | −14313 | −176 | 533 | 172 |

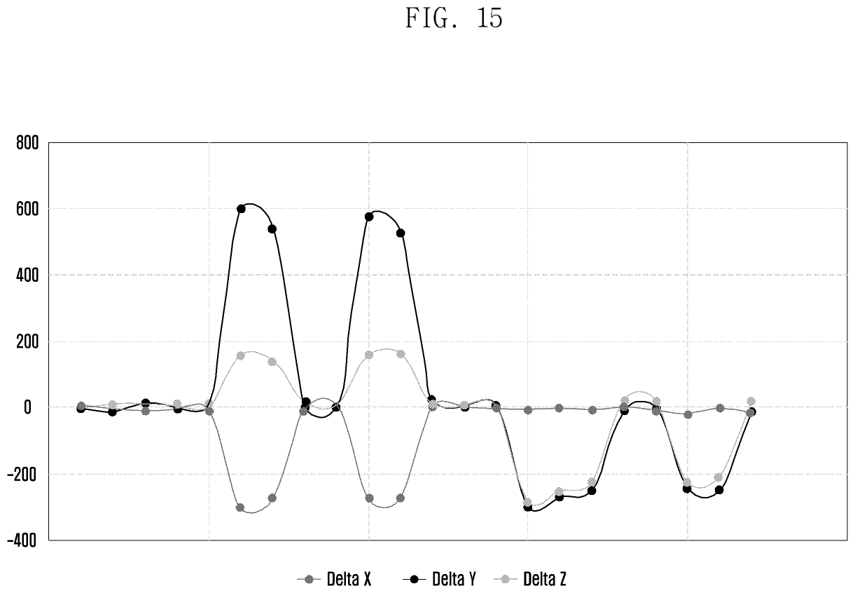

FIG. 15 is a graph generated based on the data of Table 3, and it can be seen that, for example, in a situation where an external force exists due to an external magnetic field such as a folding fixation magnet, wireless charger, or accessory case of the electronic device, a folded state and/or folding angle may be checked by driving the electromagnetic force generation member by adjusting a current direction, current intensity, or cycle, and checking an actual change amount (delta) through a geomagnetic sensor. With reference to FIG. 15, it can be seen that, although an external magnetic field exists when the electronic device is folded, a change amount in magnetic field of 500 mT or more occurs in the y-axis, for example. For example, with reference to the first row of Table 3, in a state where an external magnetic field exists and the WPC antenna is turned off, the magnetic field may be measured to be approximately 4840 mT, −4130 mT, and −14450 mT in the x-, y-, and z-axis, respectively, and with reference to the second row, in a state where current is applied, the magnetic field may be measured to be approximately 4700 mT, −3580 mT, and −14400 mT in the x-, y-, and z-axis, respectively, such that a change amount (delta) of approximately −140 mT, 550 mT, and 50 mT may be measured compared to the antenna turned-off state. Hereinafter, Table 4 is a result of measuring change amounts of the x-, y-, and z-axis of the geomagnetic sensor due to a folding fixation magnet, and a magnetic field generated through the electromagnetic force generation member, when the folding angle of the electronic device is approximately 90 degrees.

TABLE 4

| | RAW DATA(mT) | | | Delta | | |
|---|---|---|---|---|---|---|
| | x | y | z | x | y | z |
| Current OFF | 7016 | −6732 | −17517 | 0 | 0 | 0 |
| | 7013 | −6746 | −17509 | −3 | −14 | 8 |
| | 7016 | −6746 | −17517 | 0 | −14 | 0 |
| | 7009 | −6749 | −17519 | −7 | −17 | −2 |
| Current ON | 7036 | −6692 | −17545 | 20 | 40 | −28 |
| | 7036 | −6695 | −17524 | 20 | 37 | −7 |
| | 7043 | −6712 | −17536 | 27 | 20 | −19 |
| Current OFF | 7029 | −6749 | −17509 | 13 | −17 | 8 |
| | 7026 | −6756 | −17512 | 10 | −24 | 5 |
| | 7029 | −6746 | −17502 | 13 | −14 | 15 |
| | 7023 | −6739 | −17517 | 7 | −7 | 0 |
| Current ON | 7036 | −6695 | −17529 | 20 | 37 | −12 |
| | 7049 | −6712 | −17517 | 33 | 20 | 0 |
| | 7049 | −6702 | −17505 | 33 | 30 | 12 |
| Current OFF | 7036 | −6749 | −17486 | 20 | −17 | 31 |
| | 7039 | −6749 | −17493 | 23 | −17 | 24 |
| | 7019 | −6739 | −17471 | 3 | −7 | 46 |
| Current ON | 7029 | −6702 | −17495 | 13 | 30 | 22 |
| | 7046 | −6699 | −17495 | 30 | 33 | 22 |
| | 7029 | −6709 | −17481 | 13 | 23 | 36 |
| Current OFF | 7023 | −6735 | −17447 | 7 | −3 | 70 |

Table 4 shows that, when a folding angle of the electronic device is approximately 90 degrees, a change amount (delta) in sensor values of the x-, y-, and z-axis of the geomagnetic sensor caused by an operation of the electromagnetic force generation member, for the sensor values of the x-, y-, and z-axis of the geomagnetic sensor caused by a folding fixation magnet, is generally low, approximately 40 or less in the x-, y-, and z-axis, respectively. For example, when an external magnetic field exists and the electronic device is in an approximately 90-degree folded state, with reference to the first row of Table 4, the magnetic field may be measured to be approximately 7010 mT, −6740 mT, and −17510 mT in the x-, y-, and z-axis, respectively, in a state where WPC antenna is turned off (current is turned off), and with reference to the second row, in a state where current is applied (current is turned on), the magnetic field may be measured to be approximately 7040 mT, −6700 mT, and −17540 mT in the x-, y-, and z-axis, respectively, and a change amount (delta) of approximately 20 mT, 40 mT, and 20 mT may be measured compared to the current turned-off state. According to an embodiment, a folding angle of the electronic device may be determined by driving the electromagnetic force generation member in an unfolded state of the electronic device. For example, when an external force that operates at a specific frequency such as an external magnetic field or wireless charger is acting, the folded state or folding angle of the electronic device may be checked by driving the electromagnetic force generation member based on a specific frequency, specific antenna, and specific current intensity, thereby avoiding the external force.

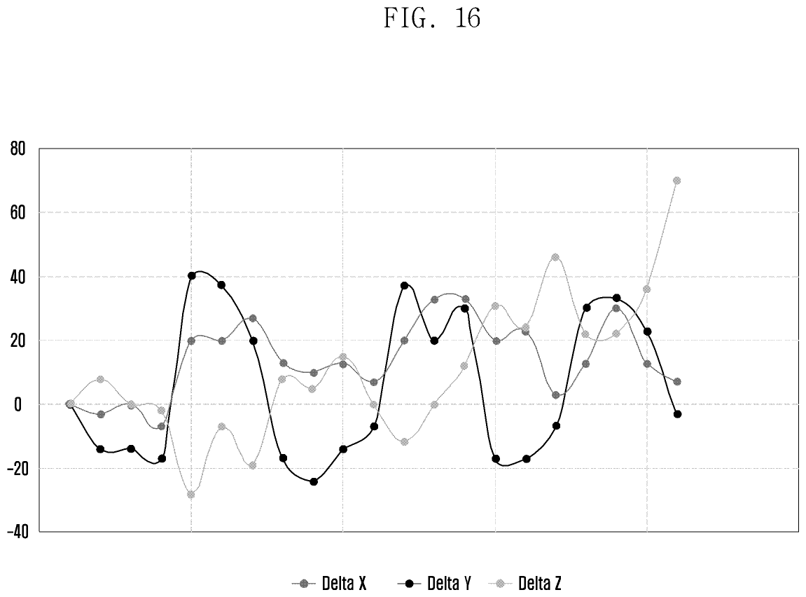

FIG. 16 is a graph generated based on the data of Table 4, and it can be seen that, for example, a change amount (delta) value of the x-, y-, and z-axis of the geomagnetic sensor becomes smaller as the distance from the electromagnetic force generation member (e.g., WPC 455 in FIG. 4) increases. Compared to the example of

FIG. 15, where a change in the y-axis of approximately 600 mT occurs, it can be seen that, in the folded state of FIG. 16, a change amount of approximately 40 mT occurs as the distance from the electromagnetic force generation member increases.

According to an embodiment, in a situation where a magnetic field change caused by a specific external force of the electronic device occurs, a folding angle change may be checked by causing a change in a magnetic field generated from an electromagnetic force generation member according to adjustment of a current direction, a current intensity, or a frequency applied to the electromagnetic force generation member when the folding angle changes.

According to an embodiment, after a change in a magnetic field by an electromagnetic force generation member is checked, an angle of the electronic device may further be checked by using a motion sensor (e.g., the motion sensor 443 in FIG. 4) of the electronic device.

According to an embodiment, the electronic device (e.g., the electronic device 101, 200, 300, or 400 in FIG. 1, FIG. 2, FIG. 3, or FIG. 4) may include a flexible display (e.g., the display 210, 310, or 410 in FIG. 2, FIG. 3, or FIG. 4), a first housing (e.g., the first housing 201 or 301 in FIG. 2 or FIG. 3) and a second housing (e.g., the second housing 202 or 302 in FIG. 2 or FIG. 3) to which the flexible display is mounted and which are connected by a rotatable structure to be folded or unfolded, a geomagnetic sensor (e.g., the sensor 440 in FIG. 4), at least one electromagnetic force generation member (e.g., the electromagnetic force generation member 450 in FIG. 4), and a processor (e.g., the processor 420 in FIG. 4) operatively connected to the geomagnetic sensor and the at least one antenna, and the processor may be configured to check a first sensor value based on the first sensor value being measured to be greater than or equal to a specified value through the geomagnetic sensor, to select operation conditions for the at least one electromagnetic force generation member based on the at least one sensor value, to drive the at least one electromagnetic force generation member based on the operation conditions, and to determine a folded state of the first housing and the second housing based on the second sensor value measured by the geomagnetic sensor according to the driving of the at least one electromagnetic force generation member.

According to an embodiment, the electronic device may further include memory for storing reference value-related information for the sensor value of the geomagnetic sensor.

According to an embodiment, the memory may store operation-related information for the electromagnetic force generation member in association with the reference value-related information, and the processor may check the operation-related information based on the reference value-related information and may select the operation conditions.

According to an embodiment, the processor may check the first sensor value based on the reference value-related information, and may select the operation conditions so as to avoid the first sensor value.

According to an embodiment, the reference value-related information may include data regarding a magnitude, a change amount, a change direction, or a frequency change for each axis of sensor values measured with respect to various external forces for the geomagnetic sensor.

According to an embodiment, the reference value-related information may include data regarding a magnitude, a change amount, a change direction, or a frequency change for each axis of sensor values measured according to driving of the at least one electromagnetic force generation member with respect to various external forces for the geomagnetic sensor.

According to an embodiment, the processor may determine the folded state to be an unfolded state when the second sensor value is not checked for a predetermined period of time or a change amount within a designated range from the specified value is detected.

According to an embodiment, the processor may update the reference value-related information according to a sensor value measured through the geomagnetic sensor.

According to an embodiment, the processor may be configured to change the specified value based on a change rate of the first sensor value.

According to an embodiment, the processor may check the first sensor value based on the reference value-related information, and may select and drive an electromagnetic force generation member having a frequency characteristic that avoids the first sensor value among the at least one electromagnetic force generation member.

According to an embodiment, a method for an electronic device including a first housing and a second housing to which a flexible display is mounted and which are connected in a rotatable structure to be folded or unfolded, the method may include: checking a first sensor value based on the first sensor value being measured to be greater than or equal to a specified value through a geomagnetic sensor of the electronic device; selecting operation conditions for at least one electromagnetic force generation member of the electronic device based on at least one sensor value; driving the at least one electromagnetic force generation member based on the operation conditions; and determining a folded state of the first housing and the second housing based on the second sensor value measured by the geomagnetic sensor according to the driving of the at least one electromagnetic force generation member.

According to an embodiment, memory of the electronic device may store reference value-related information for the sensor value of the geomagnetic sensor.

According to an embodiment, the memory may store operation-related information for the electromagnetic force generation member in association with the reference value-related information, and the selecting of the operation conditions may include checking the operation-related information based on the reference value-related information, and selecting the operation conditions.

According to an embodiment, the selecting of the operation conditions may include checking the first sensor value based on the reference value-related information, and selecting the operation conditions so as to avoid the first sensor value.

According to an embodiment, the reference value-related information may include data regarding a magnitude, a change amount, a change direction, or a frequency change for each axis of sensor values measured with respect to various external forces for the geomagnetic sensor.

According to an embodiment, the reference value-related information may include data regarding a magnitude, a change amount, a change direction, or a frequency change for each axis of sensor values measured according to driving of the at least one electromagnetic force generation member with respect to various external forces for the geomagnetic sensor.

According to an embodiment, the folded state determining operation may determine the folded state to be an unfolded state when the second sensor value is not checked for a predetermined period or a change amount within a designated range from the specified value is detected.

According to an embodiment, an operation of updating the reference value-related information according to a sensor value measured through the geomagnetic sensor may further be included.

According to an embodiment, an operation of changing the specified value based on a change rate of the first sensor value may further be included.

According to an embodiment, an operation of checking the first sensor value based on the reference value-related information and selecting an electromagnetic force generation member having a frequency characteristic that avoids the first sensor value among the at least one electromagnetic force generation member may further be included.

The embodiments disclosed in the present document are provided as examples merely for easily explaining the technical contents and helping understand the technical contents, but not intended to limit the scope of the technology disclosed in the present document. Therefore, the scope of the technology disclosed in the present document should be interpreted as including all alterations or modifications derived from the technical spirit of various embodiments disclosed in the present document in addition to the embodiments disclosed herein.

The electronic device according to various examples may be one of various types of electronic devices. The electronic devices may include, for example, a portable communication device (e.g., a smartphone), a computer device, a portable multimedia device, a portable medical device, a camera, a wearable device, or a home appliance. According to an example of the disclosure, the electronic devices are not limited to those described above.

It should be appreciated that various examples of the disclosure and the terms used therein are not intended to limit the technological features set forth herein to particular examples and include various changes, equivalents, or replacements for a corresponding example. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it denotes that the element may be coupled with the other element directly (e.g., wiredly), wirelessly, or via a third element.

As used in connection with various examples of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an example, the module may be implemented in a form of an application-specific integrated circuit (ASIC).

Various examples as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an example, a method according to various examples of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various examples, each component (e.g., a module or a program) of the above-described components may include a single entity or multiple entities, and some of the multiple entities may be separately disposed in different components. According to various examples, one or more of the above-described components may be omitted, or one or more other components may be added. Alternatively or additionally, a plurality of components (e.g., modules or programs) may be integrated into a single component. In such a case, according to various examples, the integrated component may still perform one or more functions of each of the plurality of components in the same or similar manner as they are performed by a corresponding one of the plurality of components before the integration. According to various examples, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a flexible display;
a first housing and a second housing to which the flexible display is mounted and which are connected in a rotatable structure to be folded or unfolded;
a geomagnetic sensor;
at least one electromagnetic force generation member;
memory, comprising one or more storage media, storing instructions; and
one or more processors communicatively coupled to the memory, the geomagnetic sensor and at least one antenna,
wherein the instructions, when executed by the one or more processors individually or collectively, cause the electronic device to:
check a first sensor value based on the first sensor value measured through the geomagnetic sensor being greater than or equal to a specified value,
select operation conditions for the at least one electromagnetic force generation member based on at least one sensor value,
drive the at least one electromagnetic force generation member based on the operation conditions, and
determine a folded state of the first housing and the second housing based on a second sensor value measured by the geomagnetic sensor according to the driving of the at least one electromagnetic force generation member.

2. The electronic device of claim 1, wherein,
the memory is configured to store reference value-related information for a sensor value of the geomagnetic sensor.

3. The electronic device of claim 2,
wherein the memory stores operation-related information for the electromagnetic force generation member in association with the reference value-related information, and
wherein the instructions, when executed by the one or more processors individually or collectively, further cause the electronic device to check the operation-related information based on the reference value-related information, and select the operation conditions.

4. The electronic device of claim 2, wherein the instructions, when executed by the one or more processors individually or collectively, further cause the electronic device to check the first sensor value based on the reference value-related information, and to select the operation conditions so as to avoid the first sensor value.

5. The electronic device of claim 2, wherein the reference value-related information includes data regarding a magnitude, a change amount, a change direction, or a frequency change according to each axis of sensor values measured for various external forces applied to the geomagnetic sensor.

6. The electronic device of claim 2, wherein the reference value-related information includes data regarding a magnitude, a change amount, a change direction, or a frequency change according to each axis of sensor values measured by driving the at least one electromagnetic force generation member with respect to various external forces for the geomagnetic sensor.

7. The electronic device of claim 2, wherein the instructions, when executed by the one or more processors individually or collectively, further cause the electronic device to determine the folded state to be an unfolded state when the second sensor value is not checked for a predetermined period of time or a change amount within a designated range from the specified value is detected.

8. The electronic device of claim 2, wherein the instructions, when executed by the one or more processors individually or collectively, further cause the electronic device to update the reference value-related information according to sensor values measured through the geomagnetic sensor.

9. The electronic device of claim 2, wherein the instructions, when executed by the one or more processors individually or collectively, further cause the electronic device to change the specified value based on a change rate of the first sensor value.

10. The electronic device of claim 2, wherein the instructions, when executed by the one or more processors individually or collectively, further cause the electronic device to check the first sensor value based on the reference value-related information, and to select and drive an electromagnetic force generation member having a frequency characteristic that avoids the first sensor value among the at least one electromagnetic force generation member.

11. A method performed by an electronic device including a first housing and a second housing to which a flexible display is mounted and which are connected in a rotatable structure to be folded or unfolded, the method comprising:
checking a first sensor value based on the first sensor value being measured to be greater than or equal to a specified value through a geomagnetic sensor of the electronic device;
selecting operation conditions for at least one electromagnetic force generation member of the electronic device based on at least one sensor value;
driving the at least one electromagnetic force generation member based on the operation conditions; and
determining a folded state of the first housing and the second housing based on a second sensor value measured by the geomagnetic sensor according to the driving of the at least one electromagnetic force generation member.

12. The method of claim 11,
wherein memory of the electronic device stores reference value-related information for a sensor value of the geomagnetic sensor, and operation-related information for the electromagnetic force generation member in association with the reference value-related information, and
wherein the selecting of the operation conditions comprises checking the operation-related information based on the reference value-related information and selecting the operation conditions.

13. The method of claim 12, wherein the selecting of the operation conditions comprises checking the first sensor value based on the reference value-related information, and selecting the operation conditions so as to avoid the first sensor value.

14. The method of claim 12, wherein the reference value-related information includes data regarding a magnitude, a change amount, a change direction, or a frequency change according to each axis of sensor values measured for various external forces applied to the geomagnetic sensor.

15. The method of claim 11,
wherein the at least one electromagnetic force generation member of the electronic device comprises at least one of a near field communication (NFC), a magnetic secure transmission (MST), a wireless power consortium (WPC), or a touch sensing panel (TSP).

16. The method of claim 11, wherein setting information of the flexible display is adjusted based on an angle between the first housing and the second housing.

17. One or more non-transitory computer-readable storage media storing one or more computer programs including computer-executable instructions that, when executed by one or more processors of an electronic device individually or collectively, cause the electronic device to perform operations, the operations including a method of controlling the electronic device, the electronic device including a first housing and a second housing to which a flexible display is mounted and which are connected in a rotatable structure to be folded or unfolded, wherein the operations comprise:
checking a first sensor value based on the first sensor value being measured to be greater than or equal to a specified value through a geomagnetic sensor of the electronic device;
selecting operation conditions for at least one electromagnetic force generation member of the electronic device based on at least one sensor value;
driving the at least one electromagnetic force generation member based on the operation conditions; and
determining a folded state of the first housing and the second housing based on a second sensor value measured by the geomagnetic sensor according to the driving of the at least one electromagnetic force generation member.

18. The one or more non-transitory computer-readable storage media of claim 17,
wherein memory of the electronic device stores reference value-related information for a sensor value of the geomagnetic sensor, and operation-related information for the electromagnetic force generation member in association with the reference value-related information, and
wherein the selecting of the operation conditions comprises checking the operation-related information based on the reference value-related information and selecting the operation conditions.

19. The one or more non-transitory computer-readable storage media of claim 18, wherein the selecting of the operation conditions comprises checking the first sensor value based on the reference value-related information, and selecting the operation conditions so as to avoid the first sensor value.

20. The one or more non-transitory computer-readable storage media of claim 18, wherein the reference value-related information includes data regarding a magnitude, a change amount, a change direction, or a frequency change according to each axis of sensor values measured for various external forces applied to the geomagnetic sensor.
